(19) United States
(12) Patent Application Publication
(10) Pub. No.: US 2022/0207454 A1
(43) Pub. Date: Jun. 30, 2022

(54) REAL-TIME TRACKING AND MANAGEMENT OF STANDARD WORKFLOWS

(71) Applicant: Pfizer Inc., New York, NY (US)

(72) Inventors: Michael P. CAREY, Newbridge (IE); Matthew Brian ELK, Randolph, NJ (US); Maxwell Noah GOTT, Highland Park, NJ (US); René LEHOUX, Blainville (CA); Kailin Haley MACINTYRE, Basking Ridge, NJ (US); David Scott MCGETTIGAN, North Wales, PA (US); John Paul MCTERNAN, Ballysax (IE); Jefferey Maurice MOORE, Randolph, NJ (US); Cian O'MEARA, Naas (IE); Sara Tali OPPENHEIMER, New York, NY (US); Michael Henry TOMASCO, Chester, NJ (US); Yiming XIAO, Hartsdale, NY (US)

(21) Appl. No.: 17/607,341

(22) PCT Filed: Apr. 30, 2020
(86) PCT No.: PCT/US2020/030780

§ 371 Date: Oct. 28, 2021

Related U.S. Application Data
(60) Provisional application No. 62/841,174, filed on Apr. 30, 2019.

(51) Int. Cl. G06Q 10/06

(52) U.S. Cl. CPC G06Q 10/06316; G06Q 10/0633; G06Q 10/06393

(57) ABSTRACT

Lean manufacturing principles are integrated into computing components for the generation, collection, analysis, and propagation of real-time manufacturing and supply operations data. A set of role card objects determined to correspond to a received electronic plan can be selected for generating a workflow dataset representative of a standard workflow. The workflow dataset, including the selected set of role card objects, can be displayed via a graphical user interface. The GUI can facilitate scheduling, assignment, and execution of various tasks defined within the role card objects. Timed durations of executing such tasks can be compared to standard durations defined in each role card object of the workflow dataset, such that deviations from the standard durations can be determined. As variances can be problematic to operational efficiencies, techniques for dynamically generating, assigning, and analyzing datasets associated with identified problematic areas, such as variances, are provided.

### BACKGROUND OF THE INVENTION

Manufacturing and supply operations generally require enormous amounts of resources, such as manpower, machinery, and materials, among other things. To properly plan and execute operations, standardized processes are typically implemented to facilitate manageable workflows. Such processes become drastically more important for larger scale operations, as the resources become more difficult to monitor and manage. In this regard, a variety of operational improvement frameworks have been adopted by organizations seeking to eliminate waste, increase efficiency, improve quality, and/or reduce variation in operational activities, including production, maintenance, management, development, and the like. Improvement frameworks generally include a set of core principles, which organizations can adopt for preparing, executing, and improving lean implementation plans. Among other things, implementation of an improvement framework can facilitate continued improvement of operational workflows.

### SUMMARY OF THE INVENTION

Embodiments described herein are generally directed to systems and techniques for generating, analyzing, and sharing manufacturing and supply operations data in accordance with lean manufacturing principles. Manufacturing and supply operations data can be generated and curated by integrating lean manufacturing principles into computing components, any of which can be interacted with via a set of graphical user interfaces. Among other things, the generated operations data can be employed by a variety of data analytics tools for identifying areas of operational improvement, sharing identified improvement areas with defined user roles within an organization, viewing real-time status of operations, or generating metrics data and/or predictive operational assessments based on real-time and/or historic operations data.

In some embodiments, a computing device can include a memory having a plurality of role card objects stored therein. Each role card object can include, among other things, corresponding metadata and a corresponding standard duration. The computing device can select a set of role card objects from the stored plurality of role card objects based on a received electronic plan. More specifically, a role card object can be selected from the stored plurality of role card objects if the computing device determines that its corresponding metadata corresponds to a portion of the received electronic plan. The computing device can generate a workflow dataset based on the selected set of role card objects, and provide for display a graphical user interface (GUI) that presents therein the generated workflow dataset. An actual duration specific to each of the presented role card objects can be recorded by the computing device based on a corresponding set of inputs received via the GUI. Based on the defined standard durations and the recorded actual durations, the computing device can calculate a variation value specific to each of the presented role card objects. The computing device can then store the calculated variation values, from which a variety of analytics data can be generated, provided for display, and/or shared amongst user accounts and/or roles. By way of non-limiting example, the computing device can identify an inefficiency (e.g., a pattern of threshold-exceeding variation values) associated with a particular role card object, and provide for display a chart, analytics data, or another notification indicative of the identified inefficiency. In this way, the GUI can be employed to graphically inform users of identified inefficiencies of the operational workflow.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWING

The present invention is described in detail below with reference to the attached drawing figures, wherein:

FIG. 1 is an exemplary system diagram in accordance with some embodiments of the present disclosure;

FIG. 2 is a block diagram of an exemplary digital operations system, in accordance with some embodiments of the present disclosure;

FIG. 3 is a block diagram of an exemplary standard work component, in accordance with some embodiments of the present disclosure;

FIG. 4 is a block diagram of an exemplary visual management component, in accordance with some embodiments of the present disclosure;

FIGS. 5-22 are illustrations showing exemplary graphical user interface implementations for interacting with a standard work component, in accordance with some embodiments of the present disclosure;

FIGS. 23-29 are illustrations showing exemplary graphical user interface implementations for interacting with a visual management component, in accordance with some embodiments of the present disclosure;

FIG. 30 is a flow chart depicting an exemplary process flow for generating manufacturing and supply operations data, in accordance with some embodiments of the present disclosure;

FIG. 31 is a flow chart depicting an exemplary process flow for analyzing manufacturing and supply operations data, in accordance with some embodiments of the present disclosure;

FIG. 32 is a flow chart depicting an exemplary process flow for cascading manufacturing and supply operations data, in accordance with some embodiments of the present disclosure; and

FIG. 33 is a block diagram of an exemplary computing environment suitable for use in accordance with some embodiments of the present disclosure.

### DETAILED DESCRIPTION OF THE INVENTION

Overcoming process challenges in manufacturing and supply operations can be an extraordinarily complex task. Organizations seek out process control improvement frameworks that can help reduce waste, variation, and costs, while driving operational excellence through continuous improvement, workplace optimization, and development of quality systems. Many operational improvement frameworks are founded on several fundamental ideas. While the terminology between frameworks may differ, each commonly reference core lean concepts, such as information, focus, and action, among others. An organization's capabilities for accurately capturing manufacturing and supply operations data (i.e., information) can help an organization identify losses in the manufacturing and supply operations process. Capturing the manufacturing and supply operations data can thus enable the organization to identify (i.e., focus) their priorities, thereby providing a foundation for taking appropriate and sustained action for continued improvement (i.e., action).

Within these core concepts is a principle of utilizing visual management techniques. The concept of visual management aims to make processes or other operational information easily digestible through relatively quick visual observations. Visual management techniques can include the utilization of graphical depictions, such as graphs, tables, diagrams, or colors, among other things, each of which can be viewed throughout the entire organization, from team members on the shop floor to managers and executives.

Integrated Manufacturing Excellence (IMEx), Six-Sigma, Lean, and Lean Six, are just a few examples of such improvement frameworks, or lean methodologies, that facilitate the continuous improvement of operational workflows. These frameworks have proven to be extremely valuable to organizations striving to optimize and improve the quality of their manufacturing and supply operations. Although the vast and proven benefits of improvement frameworks generally outweigh the costs of implementation, these costs are factors that can become difficult to overlook.

Despite the many advancements in computing technologies, conventional methodologies for capturing, analyzing, and sharing manufacturing and supply operations data rely heavily on manually-intensive tasks, which oftentimes require collaboration between various employees and roles of an organization. For instance, a first team of an organization may be in charge of planning (e.g., aligning demand with manufacturing capacity) to create schedules (a “plan”) for certain operations (e.g., production, procurement, maintenance, development, management). A second team of the organization may receive the plan to then prepare a detailed plan (“standard work” plan) that defines a working standard of each operator, or team of operators, having a role in the execution of the detailed plan. The second team then determines all of the standardized steps or processes (“role cards”) that each operator or team of operators must perform, and further determines the standard operating times (e.g., expected duration) associated with the steps or processes. Oftentimes, the second team prepares a graphical depiction of the standard workflow that can be viewed by anyone within the organization, including the operator or team of operators. The operator or team of operators can then obtain the determined steps or processes, and begin executing them under an expectation that they should not exceed the standard operating time. As the planned operation(s) begin, the operator or team of operators can maintain a log that describes any problems that may occur during the performance of their tasks, in addition to any known deviations from the standard operating times. In accordance with most improvement frameworks, a third team can analyze the logged information to determine areas of inefficiencies or other problematic areas of the planned operations, such as those that may occur on a production line, by way of example. In some instances, if information regarding a problematic area is to be shared or escalated within the organization, the third team must deliver this information to a fourth team that can implement process changes for continued improvement.

From generating planning data and defining standard work, to analyzing operational data (e.g., production, maintenance, laboratory data) for facilitating continuous improvement, the number of processes and team members involved can be extensive. Problems associated with disparate or incompatible systems between locations and/or teams, human error in data entry, loss of information, and general inefficiencies of manual tasks, are factors that can negatively affect the continued improvement process. As such, a unified system for dynamically handling all aspects of the improvement framework, through which areas of improvement can be identified and acted upon, would be beneficial. To realize the full potential of an improvement framework, embodiments described herein are generally directed to systems and techniques for generating electronic standard workflows, among other things, from which all data necessary for efficiently and optimally implementing the improvement framework can be generated, analyzed, and shared throughout an organization.

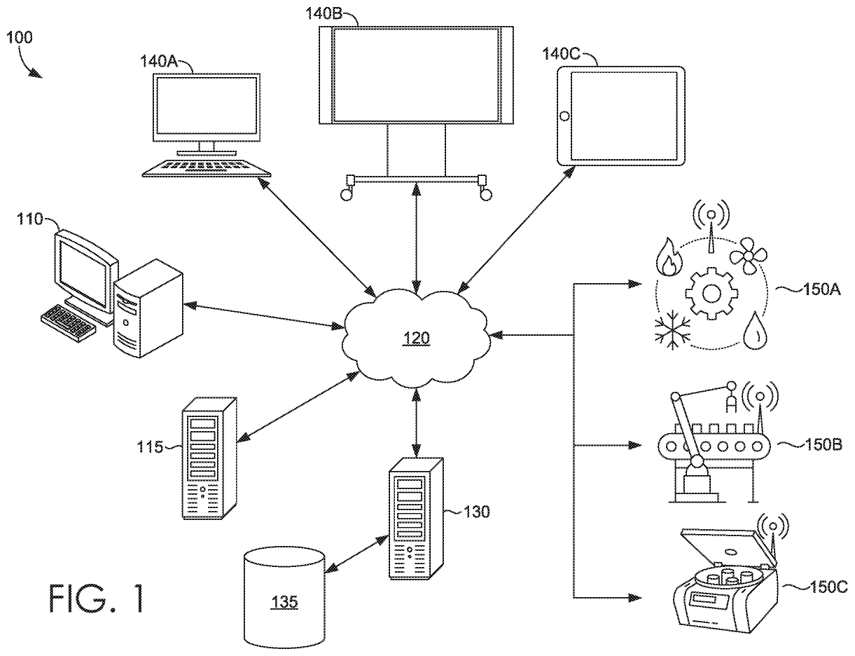

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

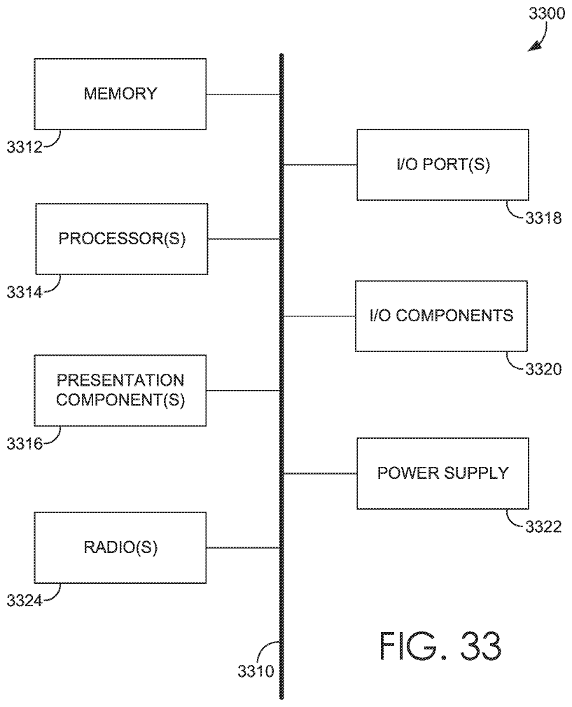

In accordance with some embodiments, example operating environment 100 can include one or more client devices, such as client devices 110, which can include a computing device as described in accordance with FIG. 33. In some embodiments, client device 110 can be employed to generate an electronic plan. In accordance with various embodiments, an electronic plan can include an operational plan defined in an electronic dataset, whereby the operational plan defines production (e.g., shop floor processes), maintenance, management, development (e.g., laboratory) activities, and/or other operations. The client device 110 can include a planning application (e.g., SAP, LIMS) installed thereon, or can remotely access the planning application provided or hosted by a remote server 115. In some embodiments, the planning application can be accessed via a network 120, which can include a LAN, WAN, PAN, and/or the Internet, by way of example. In various embodiments, the generated electronic plan can be stored in a memory of the remote server 115, retrievable by authenticated computing devices via the network 120, or can be communicated via the network 120 to one or more digital operations servers, such as digital operations server 130, for storage in a memory or a database 135 (both referenced herein as the database 135) of the digital operations server 130. It is contemplated that the database 135 does not necessarily need to be included in the digital operations server 130, and can be remotely accessed via the network 120. In various embodiments, the database 135 can include any type of data store, such as a SQL database or a distributed ledger (e.g., blockchain), among others data storage means.

In some embodiments, the example operating environment 100 can further include additional client devices, such as client devices 140A, 140B, or 140C, any of which can access and/or communicate with the digital operations server 130 via the network 120. In various embodiments, the digital operations server 130 can employ one or more authentication mechanisms to provide authenticated access to the electronic plan and/or various components of the digital operations server 130. It is further contemplated that in some embodiments, the electronic plan, such as one generated by client device 110 or remote server 115, can additionally or alternatively be received or retrieved by any one of client devices 140A-140C from client device 110 or remote server 115. To this end, any one of client devices 140A-140C can access the generated electronic plan, whether stored in a local memory of the client device 140A, 140B, 140C, a memory of client device 110, a memory of server device 115, a memory of digital operations server 130, or a database 135.

In some embodiments, the example operating environment 100 can further include a plurality of sensors and/or smart devices (e.g., Internet of Things or “IoT”) devices that can generate sensor data. In some further embodiments, the sensors and/or smart devices can be associated with a variety of machines or processes associated with manufacturing, production, maintenance, testing, or the like, and can include, by way of non-limiting example, thermal and/or environmental sensors (e.g., sensor 150A), production line sensors (e.g., sensor 150B), or machine/device-specific sensors (e.g., sensor 150C). In this regard, sensors 150A-150C can generate sensor data (hereinafter also referenced as “plant data”) that can be communicated to the digital operations server 130 via network 120 for analysis, processing, and/or storage (e.g., to database 135), among other things.

On a high level, and by way of non-limiting example, a first client device, such as client device 140A, can access the digital operations server 130 via the network 120. The digital operations server 130 can prompt and/or receive authentication credentials (e.g., a first user account, password) from the client device 140A, so as to provide authenticated access to the client device 140A associated with the first user account. In some aspects, each first user account can be associated with a role, which can be defined on the digital operations server 130 or another remote server (not shown) employed to define and/or authenticate access rights, among other things. Provided that the client device 140A associated with the first user account is authenticated, the digital operations server 130 can provide a graphical first user interface (GUI) for display to the client device 140A, such that a first user associated with the first user account can employ the client device 140A, and navigate and/or perform a variety of features or operations of the digital operations server 130.

One of such features is the ability to generate a standard workflow dataset. Among other things, the database 135 of digital operations server 130 can store a plurality of electronic role card objects that can be associated with a role card type, among other things. In accordance with various embodiments, an electronic role card object can include a set of metadata that defines, among other things, a specific operation (e.g., a set of tasks), a product being made, and/or the equipment (e.g., machinery, supplies) required to make the product. More so, the electronic role card object or metadata thereof can include a defined set of tasks (e.g., production, maintenance, management, development, testing tasks) necessary to perform the specific operation when making the product. Each task of the defined set of tasks can be associated with a predefined standard duration, which can also be embedded in the metadata of the electronic role card object. As referenced herein, a standard duration corresponds to a duration in which a corresponding task, set of tasks (e.g., an operation), or a set of operations (e.g., a standard workflow) is expected to be performed (e.g., by personnel or machines). In this regard, each task defined in an electronic role card object can be associated with a corresponding standard duration, such that the electronic role card object can be associated with its own corresponding standard duration (e.g., a calculated sum of the standard duration of tasks defined therein), and a standard workflow dataset generated based on a set of electronic role card objects can also be associated with its own corresponding standard duration (e.g., a calculated sum of the standard duration of electronic role card objects included therein).

In some embodiments, the client device 140A can employ the GUI to provide an electronic plan, such as one generated by client device 110, to the digital operations server 130 for generating the standard workflow dataset. In some embodiments, an electronic plan can be selectively imported by the digital operations server 130 based on the electronic plan being selected and/or uploaded by client device 110 via the GUI. The digital operations server 130 can analyze the electronic plan to select one or more corresponding electronic role card objects stored in the database 135. For instance, the digital operations server 130 can compare and/or match one or more portions of the electronic plan to the metadata of one or more electronic role card objects to make selections thereof. In some aspects, the digital operations server 130 can determine a match between a portion of the electronic plan and an electronic role card object with high confidence (e.g., a 1:1 match) and/or with low confidence (e.g., low: <60%, medium: 61%-99%), to facilitate the selection thereof. In some embodiments, the digital operations server 130 can flag or tag a selected electronic role card object as one having been selected with a certain level of confidence (e.g., low, medium, high).

Employing the selected electronic role card objects, the digital operations server 130 can generate a workflow dataset therefrom. The generated workflow dataset can include the selected electronic role card objects, which can be arranged in an order that corresponds to the order of the portions of the electronic plan with which they were matched. Among other things, the digital operations server 130 can calculate a sum of the standard durations from the selected electronic role card objects included in the generated workflow dataset, which among other things, can be associated with the generated workflow dataset.

Once the workflow dataset is generated, the digital operations server 130 can generate a GUI that includes and/or presents the generated workflow dataset for display to the client device 140A. In some embodiments, the generated workflow dataset can be presented within a calendar view of the GUI, such that the workflow dataset is depicted with a start time and an end time based on the calculated sum of the standard durations. In some aspects, the start time can be defined within the electronic plan, which the digital operations server 130 can associate with the generated workflow dataset. In some other aspects, the start time can be defined with a default start time, which can be determined based on a current date, or a current state of the presented calendar view.

In some embodiments, the digital operations server 130 can color each role card object included in the presented workflow dataset based on the confidence flags associated therewith (e.g., the level of confidence with which the role card object was matched). For instance, role card objects selected based on a high level of confidence can be depicted with a first color (e.g., blue), while role card objects selected based on a low level of confidence can be depicted with second color (e.g., yellow). In this regard, a first user of the client device 140A can be prompted to validate the presented role card objects that were selected based on a low (e.g., less than 100%) level of confidence. In various embodiments, the digital operations server 130 can provide a GUI that can receive, from the client device 140A, a selection of a role card object requiring validation. Among other things, the digital operations server 130 can provide for display a search form, which can be auto-populated with search criteria extracted from a portion of the received electronic plan (i.e., the portion at least partially corresponding to the role card object requiring validation). In this way, the digital operations server 130 can receive a request from the client device 140A, via the GUI, to perform a search on the stored plurality of electronic role card objects, and responsively present a list of determined relevant electronic role card objects. The client device 140A can then select one of the listed electronic role card objects, and selectively request that the digital operations server 130 add the selected electronic role card object to the generated workflow dataset at a position that corresponds to the electronic role card object being validated.

In some embodiments, the digital operations server 130 can further provide features, via the GUI, for generating a custom electronic role card for inclusion in the generated workflow dataset. A custom electronic role card can include one or more definable tasks, a start time, and/or duration, among other things, which may not necessarily be desired for defining a standard of work in a corresponding operation or plan. In accordance with some embodiments, while a custom electronic role card can be added to a generated standard workflow dataset, the custom electronic role card may be deleted from the generated standard workflow dataset, while selected and/or validated electronic role cards may not.

Once all selected role card objects have been added to the workflow dataset and/or validated, each of the role cards can be considered a scheduled role card, such that the role card is associated with a start time and can be viewed by other user accounts via respective client devices. A first user can employ client device 140A to customize one or more of the electronic role cards of the presented workflow dataset, in accordance with some embodiments. The client device 140A can communicate an edit command corresponding to one of the presented role card objects to the digital operations server 130, such that the digital operations server 130 can provide for display a GUI having editable and/or non-editable fields that corresponds to the selected role card object. A first user can thus customize, via the respective client device 140A, the editable fields to define or re-define priority level, personnel or colleague assignment(s) (e.g., associated with corresponding user accounts), material(s), date(s), start time(s), duration(s), and/or comment(s), among other things, which can be saved by the digital operations server 130 based on a save command received from the client device 140A. In some further embodiments, the selected role card object can be edited such that any portion of the tasks defined therein can be assigned or re-assigned to one or more selected personnel or colleagues (e.g., associated with corresponding user accounts). In this regard, the digital operations server 130 can present a list of defined personnel or colleagues, any number of which can be selected for assignment or re-assignment to a selected task or the selected role card object. In some aspects, it is contemplated that the list of personnel or colleagues can be filtered based on role definition(s) associated the user accounts.

In some further embodiments, and by way of another non-limiting example, a second user associated with a second user account can employ a second client device, such as client device 140A, 140B, or 140C to access the digital operations server 130. Provided that the second user (e.g., second user account) was assigned to one of the scheduled role card objects or defined tasks thereof in a generated workflow dataset, the digital operations server 130 can provide for display, to the second client device 140A, 140B, or 140C, a GUI that presents at least one scheduled role card object having the second user associated therewith (e.g., as an assigned personnel or colleague). In some aspects, each assigned role card object or task thereof can be presented within a calendar view, a task view, or any combination thereof, and can further be presented based on the defined start time associated with the assigned role card object or task. The second user can employ the second client device 140A, 140B, or 140C to request additional information about a selected assigned role card object or task, whereby the digital operations server 130 can responsively provide for display a GUI that presents any or all tasks defined in the assigned role card object, in addition to a state (e.g., progress status), description, start time, standard duration, actual duration (e.g., recorded duration), and/or comment associated with each task defined therein.

In some embodiments, the GUI can include, for each role card object or task thereof assigned to the second user or second user account, one or more GUI elements that can be activated based on received input(s) to initiate or stop a timer associated with the role card object or task. Thus, when the second user is prepared to perform an assigned task(s), an input (e.g., a touch or motion gesture, a mouse click, a verbal cue) corresponding to one of the one or more GUI elements can be provided to the second client device 140A, 140B, or 140C, such that the input is communicated to the digital operations server 130 as an instruction to start or stop the associated timer. Among other things, the digital operations server 130 can generate and provide for display, to any client device having authorized access to view the scheduled role card object, a progress bar associated with any one of the role card object, task, or standard workflow dataset. In some aspects, the digital operations server 130 can further modify the color of the progress bar, associated with any one of the role card object, task, or standard workflow dataset, based on a determination that the role card object, task, or standard workflow dataset is trending in accordance with the schedule (e.g., the scheduled start time, standard duration).

In some embodiments, when the second user finishes performing an assigned task, the second user can provide an input (e.g., a touch or motion gesture, a mouse click, a verbal cue) corresponding to a GUI element via the client device 140A, 140B, or 140C, such that the input is communicated to the digital operations server 130 as an instruction to complete or finish the assigned task(s). In this regard, the digital operations server 130 can log an actual duration associated with the performed task, based on a duration the timer recorded (i.e., time between the two inputs). The digital operations server 130 can dynamically update the GUI to indicate completion of the assigned task, and further update (e.g., increase) a progress bar associated with the role card object. In some embodiments, the digital operations server 130 can store the recorded actual duration in association with the assigned task or role card object to the database 135. In some further embodiments, based on the determined completion of a task, the digital operations server 130 can determine a variance value for the task based on a calculated difference between the standard duration and the recorded actual duration associated with the task. The digital operations server 130 can further store the determined variance value in association with the task to the database 135 for further analysis.

Provided that the determined variance value of a task is negative, or in other words the recorded actual duration of the task is determined less than the associated standard duration, the digital operations server 130 can provide an indication that the task was completed as expected. On the other hand, if the determined variance value of the task is positive, or in other words the recorded actual duration of the task is determined greater than the associated standard duration, the digital operations server 130 can provide an indication that the task was completed with issue. In some embodiments, the digital operations server 130 can compare a determined variance value to a defined threshold variance value (e.g., +/−15 minutes), such that based on a determination that the determined variance value exceeds the defined threshold value, the digital operations server 130 can require the second user to provide a variance report (e.g., a text-based input) explaining the variance via an input field provided for display to the client device 140A, 140B, or 140C. In this regard, the digital operations server 130 can receive the variance report, associate the report with the determined variance value and the assigned task, and store them to the database 135 for further analysis. It is contemplated that other forms of input (e.g., voice input, optical input) can be captured and provided to the digital operations server 130 as a variance report.

Among other things described herein, the digital operations server 130 can include a variety of features and operations facilitated by included components that enable the efficient generation, analysis, and transfer of manufacturing and supply operations data. Employing generated manufacturing and supply operations data, as well as plant data received from sensors 150A-150C in accordance with some embodiments, the digital operations server 130 can efficiently collect, organize, store, and analyze a significant amount of historic and real-time electronic manufacturing and supply operations data. The historic and real-time data generated by embodiments described herein can further facilitate the generation and provision of metrics data, as well as predictive analytics data, to facilitate continuous improvement measures in accordance with an adopted improvement framework. More so, embodiments described herein can facilitate the creation and transfer (e.g., escalating, cascading) of customizable actions or initiatives across user accounts and/or roles of an organization, further optimizing the implementation of the adopted improvement framework.

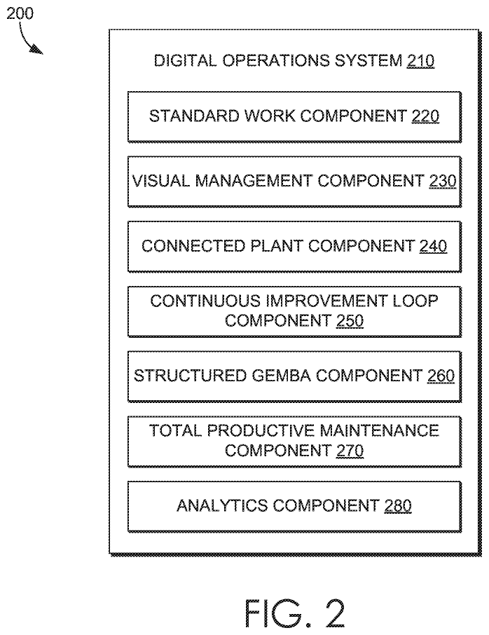

Turning now to FIG. 2, a block diagram 200 is provided, illustrating an exemplary digital operations system 210, such as one provided by digital operations server 130 of FIG. 1, for generating, storing, and analyzing electronic manufacturing and supply operations data in accordance with some embodiments of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

In various embodiments, the digital operations system 210 can include a standard work component 220, a visual management component 230, a connected plant component 240, a continuous improvement (CI) loop component 250, a structured GEMBA component 260, a total productive maintenance (TPM) component 270, and/or an analytics component 280, among other things. The digital operations system 210 is an example of a suitable architecture for implementing certain aspects of the present disclosure. It should be understood that any number of user devices, hardware, modules, or components within the scope of the present disclosure can be employed to perform the functions described in association with the digital operations system 210. In some embodiments, the digital operations system 210 can include a computing device, such as the computing device 3300 described in relation to FIG. 33 herein. As each of the described components are depicted as being included in the digital operations system 210, it is contemplated that any component depicted therein is not limited to the illustrated embodiment, and can be distributed among a plurality of computing devices, modules, or hardware devices, or in some instances, may be conflated into a single hardware device or module, such as a processor or specialized hardware device. It is also contemplated that any one or more of the described components can be completely removed from the digital operations system 210, and that one or more operations described in association with a removed component can be compensated for by one or more other components, a third-party service (e.g., API), remote computing device, or hardware device, among other things.

In various embodiments, the digital operations system 210 can be in coupled communication with a network, such as network 120 of FIG. 1, such that various components of the digital operations system 210 can send and/or receive electronic communications (e.g., data and/or datasets, inputs, signals, instructions, user interfaces) to and/or from one or more client devices (e.g., client devices 110, 140A-140C of FIG. 1), sensors (e.g., sensors 150A-150C of FIG. 1), databases (e.g., database 135 of FIG. 1), blockchain nodes, or any other component described herein. Among other things, the digital operations system 210, or any component thereof, can store any portion of received electronic communications (also referenced herein as data) into a data store, such as a database or a blockchain (e.g., via a blockchain node), as well as retrieve the stored data therefrom. In some aspects, the digital operations system 210, or any component thereof, can generate GUI elements and/or analytics data based on data stored in the data store, either of which can be communicated via the network to one or more client devices associated with a user account for display or storage. In various aspects, it is contemplated that a user account can be associated with a specific role, which can define a level of access or ability to access a particular component, or features thereof, as described in accordance with the present disclosure.

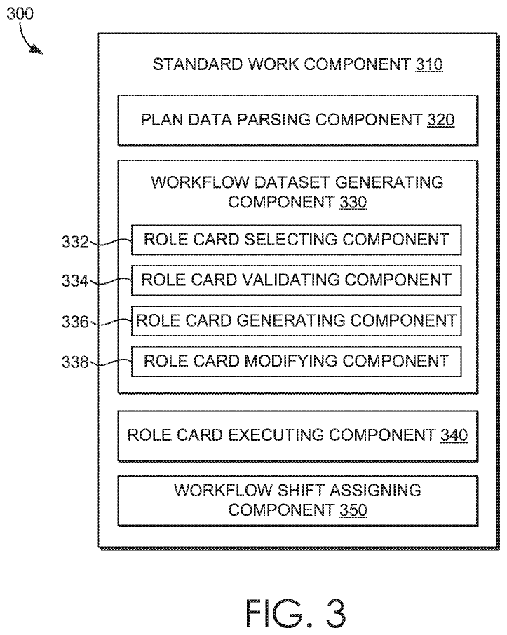

With reference now to FIG. 3, a block diagram 300 is provided, illustrating an exemplary standard work component 310, such as the standard work component 220 included in the digital operations system 210 of FIG. 2. The standard work component 310 can generate and provide for display a plan importing GUI, to a client device (e.g., client device 140A of FIG. 1), that facilitates an uploading or selecting of an electronic plan, among other things. In some embodiments, the plan importing GUI can enable the client device to import (e.g., upload, select for use by standard work component 310) the electronic plan generated via a planning application, such as SAP, LIMS or other local planning systems, by way of non-limiting example.

In various embodiments, the electronic plan can include electronic data types and/or corresponding sets of alphanumeric values that define any one or more of a product (e.g., a product name), one or more machines (e.g., machine type, model, serial number, unique identifier), one or more required operations for manufacturing the product, a location (e.g., a plant name, location, unique identifier), a start date and/or time, or a delivery date and/or time, among other things. In some embodiments, the electronic plan can include any of the foregoing in combination, such that an operation can be associated with a first location and start date, while another operation can be associated with a second location and start date, by way of non-limiting example.

The electronic plan can be formatted, such that various portions thereof can be identified. By way of example, the electronic plan can be formatted as an XML document, JSON document, spreadsheet, text document, or any other electronic document, any of which can be formatted to define a data type and a corresponding set of values. In this regard, the standard work component 310 can include a plan data parsing component 320, which can receive the imported electronic plan, and parse the electronic plan into one or more portions. The plan data parsing component 320 can identify one or more discrete portions of the electronic plan based on formatting, data type and/or values, metadata, header information, or the like, such that each discrete portion can be parsed from the electronic plan.

In some embodiments, the standard work component 310 can further include a workflow dataset generating component 330, employable to generate and provide for display an electronic workflow dataset including a set of role card objects selected based on the received electronic plan. More specifically, once the plan data parsing component 320 parses one or more portions from the electronic plan, each parsed portion can be communicated to a role card selecting component 332 of the workflow dataset generating component 330. In some embodiments, the role card selecting component 332 can receive each parsed portion of the electronic plan, and generate a query based on the received portion. The generated query can be employed by the role card selecting component 332 to search a data store (e.g., database 135) that includes a plurality of predefined role card objects stored therein.

In various embodiments, each of the role card objects can include metadata that defines all of the standardized tasks (which can be represented as data objects) required to perform an operation, such as one included in the electronic plan. As described herein, each task can be associated with (e.g., have included in the metadata) a predefined standard duration that corresponds to a standardized time for executing the task. The metadata can further define any one or more of a product (e.g., a product name), one or more machines (e.g., machine type, model, serial number, unique identifier), a location (e.g., a plant name, location, unique identifier), or other relevant electronic operation information (e.g., role card object type), any of which can enable the role card selecting component 332 to select a role card object for inclusion in a new electronic data object referenced herein as a workflow dataset.

In some embodiments, the role card selecting component 332 can select a role card object from the plurality of predefined role card objects stored in the data store, based on a determination that at least a portion of the metadata included in the role card object matches or corresponds to a portion of the imported electronic plan. In some embodiments, the role card selecting component 332 can determine a confidence level (e.g., a relevance value) of each search result (e.g., role card objects) generated by one of the workflow dataset generating component 330 or any other data store hosting device, based on a search performed thereby on the metadata of the stored role card objects. It is contemplated that the metadata of the stored role card objects can be indexed, such that searches performed on the index can facilitate expedient identification of appropriate role card objects.

In some further embodiments, the role card selecting component 332 can associate a flag or a tag with one or more of the generated search results (or determined relevant role card objects), indicating the determined confidence level associated therewith. In some aspects, one or more threshold values or ranges can be defined, such that a determined confidence level exceeding a threshold value, or falling within a range, can be associated with a particular flag or tag (e.g., low, medium, high). In some further aspects, the role card selecting component 332 can select, for each provided portion of the received electronic plan, a determined most relevant role card object (e.g., a search result having a highest confidence level).

It is contemplated that in some instances, the role card selecting component 332 can encounter situations where the selection of a role card object is uncertain. For instance, two or more role card objects can be determined equally relevant to a portion of the received electronic plan. On the other hand, while a role card object may have a highest determined relevance value, the role card selecting component 332 can determine that none of the role card objects included in the generated search results meet a defined minimal threshold relevance value (e.g., high, 100%). In various embodiments, the role card selecting component 332 can select, for each portion of the received electronic plan, any one of the equal but determined most relevant role card objects, or a role card object having a highest determined relevance value, to associate the selected role card object with a determined confidence level (e.g., flag). Based on a determination that each portion of the received electronic plan has been at least partially matched to a corresponding role card object for selection, the workflow dataset generating component 330 can generate an electronic workflow dataset that includes one or more selected set of role card objects. In some aspects, the generated workflow dataset can be stored in a data store, such as database 135 of FIG. 1.

The workflow dataset generating component 330 can then responsively generate and provide for display, to the client device, a standard workflow GUI that includes the generated workflow dataset, or a graphical depiction thereof. The displayed standard workflow dataset can present the role card objects included in the generated workflow dataset, which can be arranged in an order defined by the electronic plan. In some embodiments, the included role card objects can be presented on a schedule or calendar view of the standard workflow GUI. It is contemplated that the included role card objects can be positioned on the schedule or calendar view based on one of scheduling information (e.g., start date/time) included in the received electronic data plan, a start date/time defined by the user via client device, or a current schedule or calendar view currently displayed by the client device, among other things.

Provided that some of the role card objects included in the generated workflow dataset can be associated with at least a threshold level of certainty (e.g., high, 100%), while others may be associated with a level of certainty lower than the threshold level, the workflow dataset generating component 330 can assign a different color to each included role card based on the flag associated therewith. In this regard, the standard workflow GUI can present each included role card object with a corresponding color, indicative of a satisfactory match (e.g., equal to or greater than threshold confidence level) or an unsatisfactory match (e.g., less than threshold confidence level) requiring validation.

In this regard, in accordance with some embodiments, the standard work component 310 can further include a role card validating component 334 for enabling user-guided validation of a role card object included in the generated workflow dataset. In some embodiments, the role card validating component 334 can generate and provide for display a role card validating GUI to the client device. The role card validating GUI can be provided based on an input received from the client device, whereby the input corresponds to one of the role card objects requiring validation. In some embodiments, the role card validating GUI can include one or more editable search fields, any of which can be auto-populated with data types and/or values associated with the corresponding role card object. The client device can be employed to modify any of the search fields, and submit a search query generated based on the populated search fields.

The role card validating component 334 can receive the generated search query and employ the role card selecting component 332 to search the database for one or more of the stored role card objects determined relevant to the search query. It is contemplated that in some aspects, the role card selecting component 332 employed by the role card validating component 334 may employ a higher threshold requirement when searching the database for relevant role card objects. In this regard, the role card selecting component 332 can provide for display, via the role card validating GUI, a list of one or more search results (e.g., determined relevant role card objects) for selection via the client device. The role card validating component 334 can receive a selection that corresponds to one of the listed search results from the client device, such that the role card object requiring validation can be replaced or validated with the received selection. In some aspects, the workflow dataset generating component can dyanmically update the flag associated with the now-validated role card object, such that its corresponding color is indicative of a satisfactory match. In some aspects, the generated workflow dataset can be stored in a data store, such as database 135 of FIG. 1, based on a determination that all included role card objects are satisfactory, or in other words, validated.

In some embodiments, the standard work component 310 can further include a role card generating component 336 that enables a user of the client device to add custom, not pre-defined, or “non-standard” role card objects to a generated workflow dataset. The role card generating component 336 can generate and provide for display a role card generating GUI to the client device, based on a received “add role card” instruction generated via the displayed standard workflow GUI. The role card generating GUI enables the client device to send an “add role card” instruction to the role card generating component 336, such that a user can selectively generate custom role card objects for inclusion in a generated workflow dataset. In some aspects, the role card generating GUI can include UI elements that enable a user to add a custom role card object for themselves, another user, or team of colleagues (each also associated with a corresponding user account), to fill in any white space or gaps of activity appearing on a schedule or calendar view of a generated workflow dataset. The role card generating GUI can further include UI elements that further enable a user to provide dates, tasks, start times, duration, or comments for association and storage within a custom role card object. In some further aspects, the role card generating GUI can include UI elements that further enable a user to select other users or colleagues (e.g., user accounts) to assign or associate with a custom role card object or tasks defined therein.

In some embodiments, the standard work component 310 can further include a role card modifying component 338 that enables a user of the client device to modify various role card objects (e.g., selected, custom) included in a generated workflow dataset. The role card modifying component 338 can generate and provide a role card modifying GUI to the client device based on a received “modify role card” instruction generated via the displayed standard workflow GUI. The role card modifying GUI enables the client device to send the “modify role card” instruction to the role card modifying component 338, such that a user can selectively modify selected or custom role card objects included in a generated workflow dataset. In some aspects, the role card modifying GUI can include UI elements that enable a user to modify (e.g., add, remove, update) dates, tasks, start times, duration, and/or comments of a selected or custom role card object. In some further aspects, the role card modifying GUI can include UI elements that further enable a user to select other users or colleagues (e.g., user accounts) to assign or associate with a selected or custom role card object or the tasks defined therein.

In accordance with various embodiments described herein, role card objects included in a generated workflow dataset and/or the tasks defined therein can be assigned to or associated with one or more users (e.g., user accounts). Each assigned user can employ a client device (e.g., client device 140A, 140B, or 140C of FIG. 1) associated with the assigned user's account to access the standard work component 310. As such, the standard work component 310 can generate and provide for display the standard workflow GUI, which can present one or more role card objects and/or tasks assigned to the user based on a determination that their user account corresponds to one or more user accounts associated with a role card object and/or task. In this way, a user can employ an associated client device to access the standard work component 310 and view a scheduled listing of tasks assigned to the user.

In some embodiments, the standard work component 310 can include a role card executing component 340 that enables a user of the client device to provide a set of inputs indicating, to the role card executing component 340, that an assigned task has been initiated. As each task can be assigned to a user for execution, the user can employ the role card executing component 340 to track the status of the assigned role card object and/or task. In some embodiments, the role card executing component 340 can generate and provide for display a role card executing GUI, which can present the one or more role card objects and/or tasks assigned to the user. The role card executing GUI can further present a set of GUI elements (e.g., play button, stop button, single play/stop button) that facilitates the start and/or stop of a timer corresponding to an assigned task. In this regard, the role card executing component 340 can record an actual duration of an assigned task based on a duration of time tracked via the timer (e.g., a time between start and stop). In some aspects, the role card executing GUI can further present, for each assigned role card object or task, an associated start time, standard duration, progress bar (e.g., based on actual duration relative to standard duration), or status (e.g., not started, in progress, complete), among other things. In this way, a user can employ an associated client device to access the role card executing component 340, and visually track the progress of role card objects and/or tasks assigned to the user.

Once a user has completed an assigned role card object and/or task, the user can interact with a “complete task” UI element, associated with the assigned role card object and/or task, and presented via the role card executing GUI. The client device can thus generate a “complete task” instruction based on the detected interaction, and communicate the instruction to the role card executing component 340. Based on the received instruction, the role card executing component 340 can store (e.g., to the data store) the recorded actual duration associated with the assigned role card object and/or task.

In some embodiments, the role card executing component 340 can calculate and store a variance between the recorded actual duration and the standard duration associated with the assigned role card object and/or task, based on a received instruction to complete the assigned role card object and/or task. In some further embodiments, the role card executing component 340 can compare the calculated variance to a defined variance threshold. As such, provided that a determination is made that the calculated variance exceeds the defined variance threshold (e.g., |standard duration—actual duration)>variance threshold), the role card executing component 340 can require that a comment be provided to complete the assigned role card object and/or task. In other words, based on the determination that the calculated variance exceeds the defined variance threshold, the role card executing component 340 can generate and provide for display, to the client device, a variance comment GUI having an input field, such that an explanation (e.g., alphanumeric text, reason code, image, video) associated with the variance can be entered by the user (e.g., typed, uploaded, pasted) into the input field. The client device can thus submit the populated input field to the role card executing component 340, such that the explanation is stored by the role card executing component 340 in association with the assigned role card object and/or task. In accordance with various embodiments described herein, any combination of a calculated variance, explanation, or associated role card object and/or task stored (e.g., in the data store) can be employed for further analysis, calculation of metrics, predictive analytics, and the identification of process improvement opportunities, among other things.

In some embodiments, the standard work component 310 can further include a workflow shift assigning component 350 that enables a user of the client device to transfer assigned role card objects and/or tasks. That is, a user may wish to transfer for any reason one or more assigned role card objects and/or tasks to one or more other users (e.g., other user accounts), whether incomplete or in progress. It is contemplated that the user may be associated with the role of a shift supervisor or manager, though other roles may be considered within the purview of the present disclosure. As such, the user can view one or more role card objects and/or tasks associated with one or more other users or machines within a defined period (e.g., a range of dates and/or times). The foregoing can be presented via a shift view GUI generated and provided for display to the client device by the workflow shift assigning component 350. In some embodiments, the shift view GUI can list, by way of example, all role card objects and/or tasks scheduled within the defined period, associated start times, users, scheduled end times (e.g., determined based on standard duration), statuses, progress bars, and the like.

In some embodiments, the generated shift view GUI can include a set of GUI elements for defining a shift baseline (e.g., a time at which a new set of users will be assigned to not started, incomplete, or in-progress role card objects and/or tasks). In this way, the user can employ the set of GUI elements for defining a scheduled time at which the workflow shift assigning component 350 can search for not started, incomplete, and/or in-progress role card objects and/or tasks associated with the standard workflow dataset. In some embodiments, at a scheduled time of the shift baseline, the workflow shift assigning component 350 can redefine and associate a new start time for all role card objects and/or tasks determined associated with a not started, incomplete, and/or in-progress status, in accordance with the scheduled time.

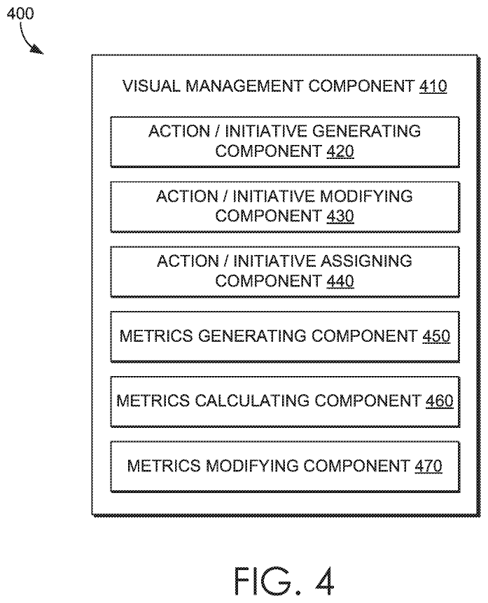

With reference now to FIG. 4, a block diagram 400 is provided, illustrating an exemplary visual management component 410, such as the visual management component 230 included in the digital operations system 210 of FIG. 2. The visual management component 410 can generate and provide for display a visual management GUI, to a client device (e.g., client device 140A, 140B, or 140C of FIG. 1), that provides a collaboration and data visualization platform providing real-time visibility of on-going operations (e.g., production, maintenance, development, management), among other things. In some embodiments, the provided visual management GUI can enable the client device to present a graphical view of key metrics generated based on data generated in real-time (e.g., scheduled start times, standard durations, recorded actual durations, calculated variances, plant data). In some embodiments, the visual management GUI can also present generated action and/or initiative datasets shared and/or assigned amongst users and/or roles. Summary modules presenting statuses of generated action and/or initiative datasets can also be presented via the visual management GUI. It is contemplated that in some non-limiting implementations, access to the visual management component 410 can be limited to the client device based on a particular role or role tier associated with the user account of the client device.

In accordance with various embodiments, an action dataset or an initiative dataset can be generated by the visual management component 410 or components thereof based on a set of inputs received from a client device associated with a user (e.g., user account). In some aspects, a generated action dataset or initiative dataset can be assigned to (e.g., associated with) one or more users based on a stored association there between. In some further aspects, the generated action dataset or initiative dataset can be escalated (e.g., re-assigned to one or more other users having a higher role tier) or cascaded (e.g., re-assigned to one or more other users having a lateral role tier) to other users based on additional associations or replacement associations being stored there between.

For purposes of reference herein, an action dataset can be generated by a user if an issue is one that can be resolved with minimal attention (e.g., a task of a role card object included in a generated workflow dataset being determined to have a calculated variance exceeding a threshold variance). An initiative dataset can be generated by a user if an issue is one that may require longer term attention (e.g., a task of a role card object included in a plurality of generated workflow datasets historically being determined to have a calculated variance exceeding a threshold variance).

A user can thus employ a respective computing device to send instructions, to the visual management component 230 or components thereof, to escalate or cascade a generated action or initiative dataset if the user believes that one or more other users and/or roles could provide guidance for resolving the issue. In some embodiments, the visual management GUI generated by visual management component 230 can present a list of action datasets and/or initiative datasets generated by and/or assigned to a user or user account associated with the client device accessing the visual management component 230. It is contemplated, however, that some user accounts can be presented with generated action and/or initiative datasets generated by and/or assigned to other users or user accounts based on an associated role or role tier, by way of example.

For purposes of the present disclosure, aspects relating to either an action dataset or initiative dataset will be referenced herein as “action/initiative,” as many features relating to each can be similarly implemented. While many features may overlap, it is contemplated that the datasets can be uniquely associated with a corresponding type (e.g., action, initiative). Moreover, in accordance with some embodiments, some features may be available to one type of dataset, while remaining unavailable to the other, or vice versa. To this end, components described as one relating to an “action/initiative” can be embodied as a single component, or multiple components (e.g., one for each type of dataset), employable for generating at least one of an action dataset or initiative dataset, among other things.

In some embodiments, the visual management component 410 can include an action/initiative generating component 420, employable to generate and provide for display to the client device an action/initiative generating GUI. The action/initiative generating GUI can be provided for display based on an “add action/initiative” instruction received from a client device. In accordance with various embodiments, the “add action/initiative” instruction can be generated by the client device via the visual management GUI, or any other GUI provided for display to the client device, such as one provided by the standard work component 310 of FIG. 3 or components thereof.

In some embodiments, the action/initiative generating GUI can include one or more input fields for providing electronic information for stored association with a new action/initiative dataset to be generated. The input fields can include fields for providing a title, a priority level, a description, an open date (e.g., date of creation or start), a due date, one or more users or user accounts, and/or dimension, among other things. In some embodiments, a dimension can correspond to a type of issue for which an action or initiative dataset is generated, such as safety, quality, supply, financials, or people/personnel, among other things. In some further embodiments, a dimension can further comprise an issue code/type and/or sub issue code/type, and can further reference a product, role card object, and/or task, among other things.

In some embodiments, another input field can be provided, which can facilitate a selection of a generated workflow dataset, a role card object included therein, a defined task of the role card object, and/or any data generated therefrom (e.g., a calculated variance), among other things. In some aspects, if the action/initiative generating GUI is provided in response to the receipt of an “add action/initiative” instruction received via another GUI, such as the variance comment GUI generated by role card executing component 340 of FIG. 3 by way of example, it is contemplated that the input fields of the action/initiative generating GUI can be auto-populated based on electronic data extracted from the other GUI.

In some embodiments, the action/initiative generating GUI can further present a “save” UI element, which can be interacted with based on a corresponding input (e.g., mouse click, gesture, verbal cue, optical input) detected by the client device. Based on the detected input, the client device can generate a “save” instruction, which is communicated to the action/initiative generating component 420 along with the populated input fields. The action/initiative generating component 420 can responsively generate an action/initiative dataset based on the received “save” instruction, and store the generated action/initiative dataset to a data store (e.g., database 135 of FIG. 1). In some further embodiments, the action/initiative generating component 420 can dynamically update the presented visual management GUI, such that the newly generated action/initiative dataset is provided for display via the client device. In some aspects, newly-generated action/initiative datasets are saved in association with an “incomplete” state, as it is contemplated that the corresponding action or initiative has yet to be acted on by a user. As such, the newly-generated action/initiative dataset can be presented via the visual management GUI with an indication corresponding to its “incomplete” state.

In some embodiments, the visual management component 410 can further include an action/initiative modifying component 430, employable to generate and provide for display to the client device an action/initiative modifying GUI. The action/initiative modifying GUI can be provided for display based on a “modify action/initiative” instruction received from a client device. In accordance with various embodiments, the “modify action/initiative” instruction can be generated by the client device via the visual management GUI, or any other GUI provided to the client device, such as one provided by the standard work component 310 of FIG. 3 or the components thereof. In some aspects, it is contemplated that a “modify action/initiative” instruction is generated via a GUI element presented adjacent to and/or corresponding to an action/initiative dataset listed via a presented visual management GUI.

In some embodiments, the action/initiative modifying GUI can include one or more input fields corresponding to those presented via the action/initiative generating GUI, such as title, priority level, description, open date (e.g., date of creation or start), due date, one or more users or user accounts, and/or dimension, among other things. Similarly, in some embodiments, another input field can be provided, presenting the workflow dataset, role card object, defined task of the role card object, and/or any data generated therefrom, among other things that may have been selected for inclusion in the generated action/initiative dataset. The action/initiative modifying GUI provided to and presented by the client device can thus enable the selective modification of any one or more of the input fields associated with the generated action/initiative dataset.

In some embodiments, the action/initiative modifying GUI can further present a “save” UI element, which can be interacted with based on a corresponding input (e.g., mouse click, gesture, verbal cue, optical input) detected by the client device. Based on the detected input, the client device can generate a “save” instruction, which is communicated to the action/initiative modifying component 430 along with any modified and/or unmodified input fields. The action/initiative modifying component 430 can responsively save the modified action/initiative dataset based on the received “save” instruction, and store the generated action/initiative dataset to the data store (e.g., database 135 of FIG. 1). In some further embodiments, the action/initiative modifying component 430 can track and store a history of any of the modifications made in association the generated action/initiative dataset. Similarly, based on the received “save” instruction, the action/initiative modifying component 430 can dynamically update the presented visual management GUI, such that the newly modified action/initiative dataset is provided for display via the client device.

In some embodiments, the action/initiative modifying GUI can further present a “complete” UI element, which can be interacted with based on a corresponding input (e.g., mouse click, gesture, verbal cue, optical input) detected by the client device. A user of the client device may interact with the “complete” UI element to mark the completion of an assigned action or initiative. Based on the detected input, the client device can generate a “complete” instruction, which is communicated to the action/initiative modifying component 430 along with any modified and/or unmodified input fields. The action/initiative modifying component 430 can responsively save the modified and/or unmodified action/initiative dataset in association with a “complete” state based on the received “complete” instruction, and store the indicated “complete” action/initiative dataset to the data store (e.g., database 135 of FIG. 1). The action/initiative modifying component 430 can track and store the state, along with any additional modifications made in association with the generated action/initiative dataset. Based on the received “complete” instruction, the action/initiative modifying component 430 can dynamically update the presented visual management GUI, such that the newly completed action/initiative dataset is either removed from display, or provided for display with an indication of its “complete” state via the client device.

In some embodiments, the action/initiative modifying GUI can further present any one of an “escalate” UI element or a “cascade” UI element, either of which can be interacted with based on a corresponding input (e.g., mouse click, gesture, verbal cue, optical input) detected by the client device. Either one of the “escalate” or “cascade” UI elements can be presented via the action/initiative modifying GUI based on a role or role tier of a user or user account associated with the client device. A user associated with a lower tier role (e.g., tier 1) can be presented with an “escalate” UI element to, in essence, assign the action/initiative dataset to another user or set of users with a higher tier role. On the other hand, a user associated with a higher tier role (e.g., tier 2 or above) can be presented with a “cascade” UI element to assign the action/initiative dataset to another user or set of users with a lower tier role. As the foregoing is merely an exemplary implementation, it is contemplated that a variety of configurations for assigning action/initiative datasets to other users or user accounts can be employed. For instance, a single “reassign” UI element can be presented, such that any user can assign the action/initiative dataset to any other user or set of users, regardless of associated role or role tier.

In some embodiments, a user of the client device may interact with the “escalate” UI element to indicate a desire to escalate (e.g., associate with one or more users having a higher tier role) the generated action/initiative dataset. Based on the detected input (e.g., mouse click, gesture, verbal cue, optical input), the client device can generate an “escalate” instruction, which is communicated to an action/initiative assigning component 440 of the visual management component 410. The action/initiative assigning component 440 can responsively save the action/initiative dataset in association with one or more users or user accounts having a higher tier role (e.g., than the user) based on the received “escalate” instruction, and store the indicated “escalated” action/initiative dataset to the data store (e.g., database 135 of FIG. 1) in association with one or more users having the higher tier role. The action/initiative modifying component 430 can track and store the state, along with any additional modifications made in association with the generated action/initiative dataset. Based on the received “escalate” instruction, the action/initiative assigning component 440 can dynamically update the presented visual management GUI, such that the “escalated” action/initiative dataset is provided for display to client device(s) associated with the one or more users associated with the higher tier role. It is contemplated that in various embodiments, the action/initiative assigning component 440 can associate the “escalated” action/initiative dataset with one or more users selected in a variety of manners. In one example, the action/initiative assigning component 440 can select all users or user accounts having a role tier one level higher than the user or user account associated with the client device. In another example, the action/initiative assigning component 440 can generate and provide for display a GUI that facilitates the selection of one or more users or user accounts and/or higher role tier(s).

In some other embodiments, a user of the client device may interact with the “cascade” UI element to indicate a desire to cascade (e.g., associate with one or more users having a lower tier role) the generated action/initiative dataset. Based on the detected input (e.g., mouse click, gesture, verbal cue, optical input), the client device can generate a “cascade” instruction, which is communicated to the action/initiative assigning component 440 of the visual management component 410. The action/initiative assigning component 440 can responsively save the action/initiative dataset in association with one or more users or user accounts having a lower tier role (e.g., lower than the user) based on the received “cascade” instruction, and store the indicated “cascaded” action/initiative dataset to the data store (e.g., database 135 of FIG. 1) in association with one or more users having the lower tier role. The action/initiative modifying component 430 can track and store the completion state, along with any additional modifications made in association with the generated action/initiative dataset. Based on the received “cascade” instruction, the action/initiative assigning component 440 can dynamically update the presented visual management GUI, such that the “cascaded” action/initiative dataset is provided for display to client device(s) associated with the one or more users associated with the lower tier role. It is contemplated that in various embodiments, the action/initiative assigning component 440 can associate the “cascaded” action/initiative dataset with one or more users selected in a variety of manners. In one example, the action/initiative assigning component 440 can select all users or user accounts having a role tier one level lower than the user or user account associated with the client device. In another example, the action/initiative assigning component 440 can generate and provide for display a GUI that facilitates the selection of one or more users or user accounts and/or lower role tier(s).

In some embodiments, the action/initiative modifying GUI can further present a “convert” UI element, which can be interacted with based on a corresponding input detected by the client device. The “convert” UI element can be presented as a single GUI element, or a set of GUI elements that are independently selectable for converting one of an action dataset to an initiative dataset, or an initiative dataset to an action dataset. A user of the client device may interact with the “convert” UI element to select the type (e.g., action or initiative) of dataset the presented input fields are to be saved in. Based on the detected input (or selected type), the client device can generate a “convert” instruction, which is communicated to the action/initiative modifying component 430 along with any modified and/or unmodified input fields. The action/initiative modifying component 430 can responsively save the modified and/or unmodified action/initiative dataset as the selected type (e.g., action or initiative) of action dataset based on the received “convert” instruction, and store the indicated “converted” action/initiative dataset to the data store (e.g., database 135 of FIG. 1). The action/initiative modifying component 430 can track and store the converted state, along with any additional modifications made in association with the converted action/initiative dataset. Based on the received “converted” instruction, the action/initiative modifying component 430 can dynamically update the presented visual management GUI, such that the converted action/initiative dataset is provided for display via the client device as one of a corresponding action dataset or initiative dataset.

In some embodiments, the visual management component 410 can include a metrics generating component 450 employable to generate and provide for display to the client device one or more metric GUIs presenting metrics data (e.g., statistics, charts, values, or the like), which can be defined and/or calculated via the digital operations system (e.g., digital operations system 210) or components thereof. The generated metrics GUIs can be presented in a visual management GUI, such as one generated and provided for display by the visual management component 410. In various embodiments, metrics data or functions thereof can be defined manually (e.g., based on received user input received via a metrics generating GUI) or automatically (e.g., dynamically calculated based on data stored in the data store).

In some further embodiments, metrics data can be calculated by a metrics calculating component 460 based on any one or more stored action datasets and/or initiative datasets associated with one or more selected dimensions thereof. The visual management component 410 can employ the metrics calculating component 460 for automatically calculating metrics data for a generated metrics GUI based on any type of data or dataset (e.g., action/initiative datasets, workflow dataset, role card object, plant data) stored in the data store.

In some aspects, metrics data can be calculated as a function of any one or more of a defined set of input fields, variables, time frames, personnel, roles, products, locations, metadata, and the like, any of which can be manually or automatically defined. In some other aspects, the metrics data can be calculated as a function of one or more dimensions, a time period (e.g., a range of dates), and/or any portion of data (e.g., associated workflow dataset, role card object, task, calculated variance, plant data) associated with datasets having the one or more selected dimensions. It is contemplated that any issue for which an action/initiative dataset was generated can include a set of defined dimension(s), time(s), and other associated data based on the corresponding input fields populated upon the generation and/or modification thereof, as described herein.

By way of non-limiting example, an exemplary implementation for providing a metrics GUI to indicate schedule adherence (e.g., actual vs. standard durations) for a particular product or location is provided. The metrics calculating component 460 can retrieve a set of action/initiative datasets from the data store, each retrieved action/initiative dataset being associated with a “supply” dimension and associated date(s) (e.g., start date, end date, creation date, assigned date) that fall within a specified range. The metrics calculating component 460 can thus extract one or more portions of data (e.g., calculated variance) from the retrieved set of action/initiative datasets that is defined as being relevant to the metrics (e.g., schedule adherence) being calculated. The metrics calculating component 460 can then calculate the metrics based on the extracted portions of data and a defined formula, such as a total amount of variance for each date associated with the extracted portions of data. In some further embodiments, the metrics calculating component 460 can provide the calculated metrics data to the metrics generating component 450, which can responsively present the calculated metrics in a graphical manner (e.g., a chart, diagram, or value(s)) via the visual management GUI, by way of example. In some aspects, each presented metrics GUI can be associated with an expansion GUI element that facilitates the presentation of a detailed view of all data or datasets (e.g., action/initiative datasets) associated with the calculated metric, among other things.

In some embodiments, the visual management GUI can include an “add metrics” GUI element that can be interacted with via the client device. Based on a detected interaction with the “add metric” GUI element, the client device can generate an “add metrics” instruction for communication to the metrics generating component 450 of the visual management component 410. In some further embodiments, the metrics generating component 450 can generate and provide for display a metrics generating GUI to the client device based on the received “add metrics” instruction. The displayed metrics generating GUI can include, for instance, a set of selectable dimensions and/or predefined metrics that can be calculated for a selected dimension. In some aspects, displayed metrics generating GUI can include further input fields that can be custom defined, or selected, based on a variety of data types (e.g., workflow datasets, role card objects), variables (e.g., dates, tasks, locations, products, personnel, machines roles), or other portions of data (e.g., calculated variances) from which various metrics can be determined.

In some embodiments, the metrics generating GUI can further present a “save” UI element, which can be interacted with based on a corresponding input (e.g., mouse click, gesture, verbal cue, optical input) detected by the client device. Based on the detected input, the client device can generate a “save” instruction, which is communicated to the metrics generating component 450 component 420 along with the populated input fields. The metrics generating component 450 can responsively generate a metrics GUI based on the received “save” instruction and any metrics data calculated by metrics calculating component 460.

In some embodiments, the visual management component 410 can further include a metrics modifying component 470, employable to generate and provide for display to the client device a metrics modifying GUI. The metrics modifying GUI can be provided for display based on a “modify metrics” instruction received from a client device. In accordance with various embodiments, the “modify metrics” instruction can be generated by the client device via the visual management GUI, or any other GUI provided to the client device. In some aspects, it is contemplated that a “modify metrics” instruction is generated via a GUI element presented adjacent to and/or corresponding to a metrics GUI included in a presented visual management GUI. In some embodiments, the metrics modifying GUI can include one or more input fields corresponding to those presented via the metrics generating GUI. The metrics modifying GUI provided to and presented by the client device can thus enable the selective modification of any one or more of the input fields associated with the generated metrics GUI.

In some embodiments, the metrics modifying GUI can further present a “save” UI element, which can be interacted with based on a corresponding input (e.g., mouse click, gesture, verbal cue, optical input) detected by the client device. Based on the detected input, the client device can generate a “save” instruction, which is communicated to the metrics modifying component 470 along with any modified and/or unmodified input fields. The metrics modifying component 470 can responsively save the modified metrics GUI based on the received “save” instruction, and employ the metrics calculating component 460 to recalculate any metrics data based on the modified and/or unmodified input fields. Based on the received “save” instruction, the metrics modifying component 470 can dynamically update the presented visual management GUI, such that the newly modified metrics GUI is provided for display via the client device.

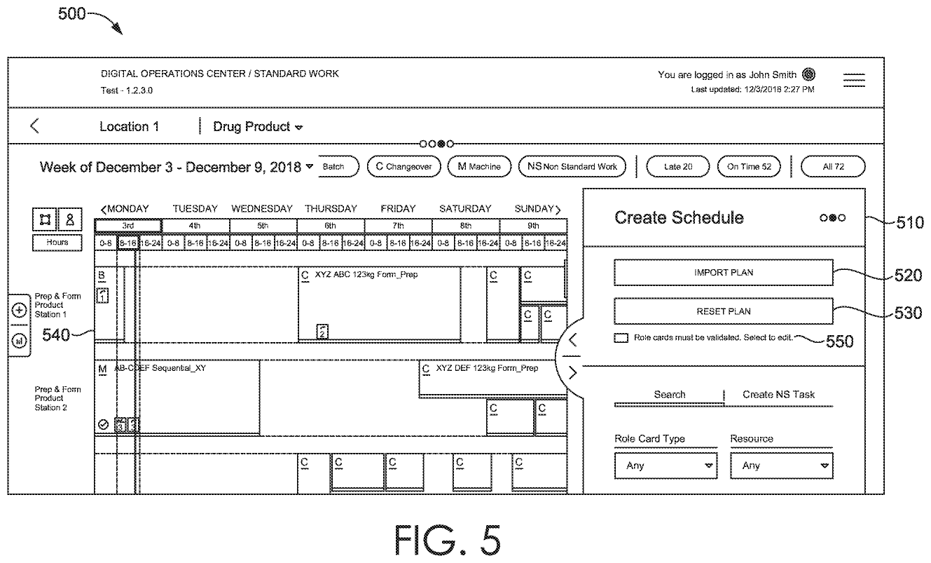

Looking now to FIGS. 5-26, various illustrations are provided depicting exemplary graphical user interface (GUI) features for interacting with a standard work component, such as standard work component 310 of FIG. 3. The various illustrations are provided merely as exemplary depictions, and are not intended to be limiting. It is contemplated that any of the GUIs can include alternative GUI elements, titles, content, layouts, and other visual features not depicted in the figures. In accordance with various embodiments, any of the presented GUI elements can be interacted with, such that a client device (e.g., client device 140A, 140B, or 140C of FIG. 1) can detect the interaction and generate a corresponding instruction for communication to a digital operations system 210 or component thereof.

FIG. 5 depicts an illustration of an exemplary standard workflow GUI 500, such as one generated by the standard work component 310 of FIG. 3. Depicted in the standard workflow GUI 500 is a generated plan importing GUI 510. As described in accordance with FIG. 3, the plan importing GUI 510 can present an “import plan” GUI element 520 that facilitates the uploading or selecting of an electronic plan. Based on a received electronic plan, a workflow dataset including a selected set of role card objects, such as role card object 540, can be generated and provided for display. In some aspects, the plan importing GUI 510 can further present a “reset plan” GUI element 530 that can remove or delete the generated workflow dataset or the selected role card objects therefrom. In some embodiments, the standard work component 310 can determine that one or more selected role card objects require validation, as described in accordance with role card validating component 334 of FIG. 3. In this regard, the standard workflow GUI 500 can present a notification 550 that one or more role card objects need to be validated. As described herein, any selected role card object can be depicted in a color that identifies the role card object as one requiring validation, among other things.

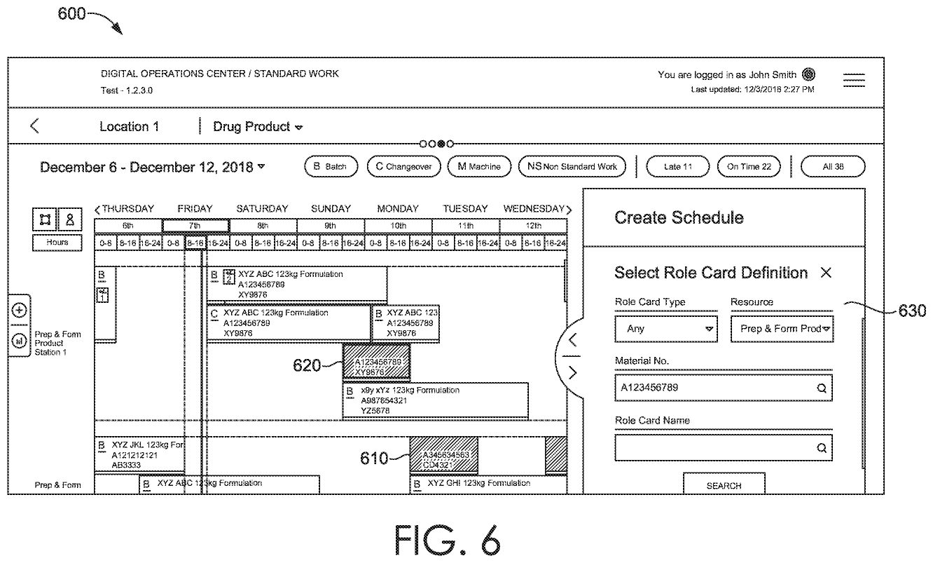

FIG. 6 depicts an illustration of an exemplary standard workflow GUI 600, such as one generated by the standard work component 310 of FIG. 3, presented after an electronic plan has been imported. Depicted in the standard workflow GUI 600 is a generated workflow dataset having at least two selected role card objects 610, 620 requiring validation. In some embodiments, a detected set of interactions corresponding to one of the role card objects (e.g., role card object 620) can cause a role card validating component, such as role card validating component 334 of FIG. 3, to generate and provide for display a role card validating GUI 630. As described in accordance with the role card validating component 334, the role card validating GUI 630 can include a set of input fields, which can be auto-populated with data types and/or values associated with the corresponding role card object 620. In this way, the role card validating GUI 630 can facilitate a search for role card objects corresponding to information provided in the presented input fields thereof.

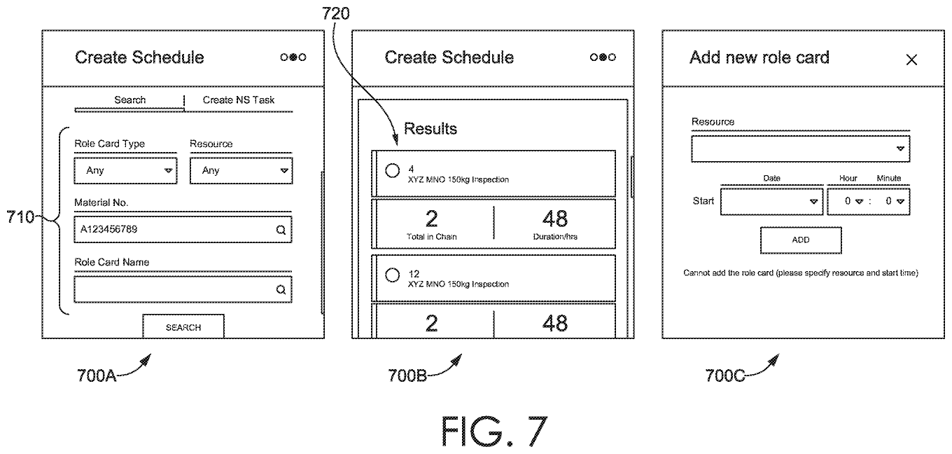

FIG. 7 depicts illustrations of exemplary role card validating GUIs 700A, 700B, 700C in accordance with some embodiments described herein. A first role card validating GUI 700A can present a set of input fields that can be auto-populated and/or manually populated. Once a search of role card objects based on the populated input fields is performed, a second role card validating GUI 700B can be generated and provided for display, presenting a list of search results (e.g., determined relevant role card objects). Any one of the listed search results 720 can be selected via a detected interaction therewith, such that based on the listed selection, a third role card validating GUI 700C can be generated and provided for display, presenting a corresponding set of input fields that further define variables associated with the selected role card object. In some aspects, one or more of the input fields of the third role card validating GUI 700C can be auto-populated or manually populated based on data parsed from the electronic plan, by way of example.

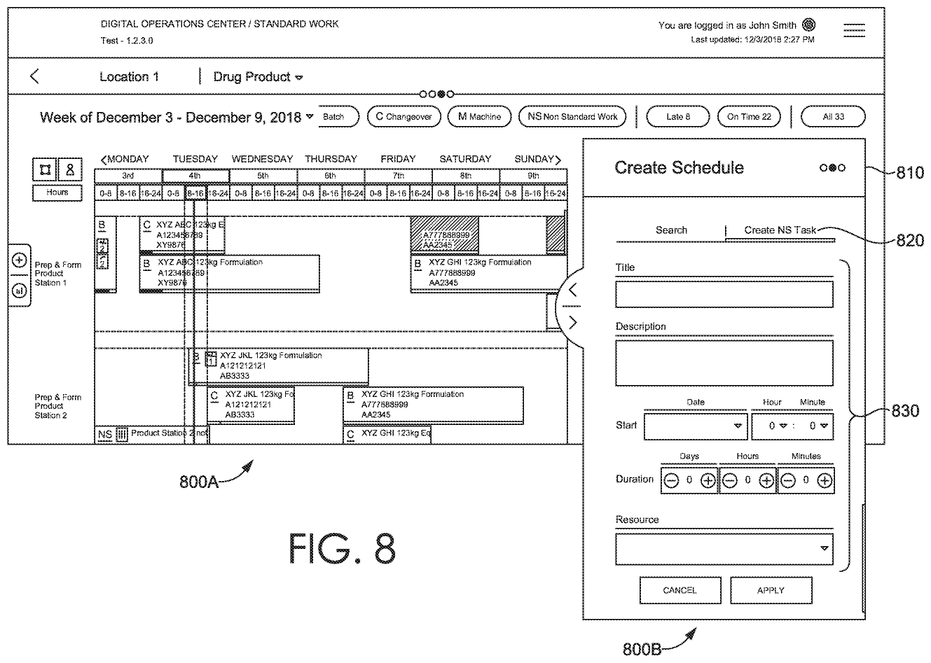

FIG. 8 depicts an illustration of an exemplary standard workflow GUI 800A, such as one generated by the standard work component 310 of FIG. 3, presented after a workflow dataset has been generated. Depicted in the standard workflow GUI 800A is a generated workflow dataset having, among other things, a set of role card objects included therein. In some embodiments, a role card generating GUI 800B can also be generated and provided for display by a role card generating component, such as role card generating component 336 of FIG. 3, based on a detected interaction with a presented GUI element 820. A detected interaction with the GUI element 820 can cause the generation of an “add role card” instruction, causing display of the role card generating GUI 800B. The role card generating GUI 800B can facilitate the generation of custom or non-selected role card objects based on a corresponding set of definable UI elements and/or input fields 830, as described in accordance with the role card generating component 336 of FIG. 3.

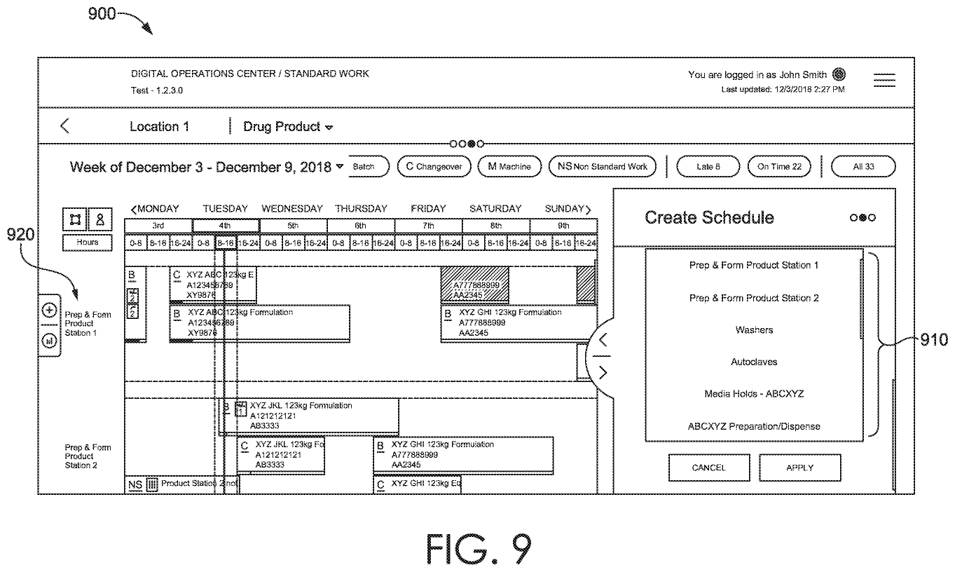

FIG. 9 depicts an illustration of an exemplary standard workflow GUI 900, such as one generated by the standard work component 310 of FIG. 3, presented while adding a custom or non-selected role card object. Depicted in the standard workflow GUI 900 is a generated workflow dataset having a selected set of role card objects. In some embodiments, the presented workflow dataset or the role objects thereof can be associated with data types and/or variables, such as resources 920 (e.g., equipment, machines, material, personnel) presented in association with the workflow dataset, by way of example. In this regard, any one of the definable UI elements and/or input fields of a role card generating GUI, such as role card generating GUI 3300B of FIG. 33, can be auto-populated with the associated data types and/or variables. In this way, a set of relevant data types and/or variables can be provided for display and/or selection to the client device, to facilitate a selection from the set when creating a custom or non-selected role card object.

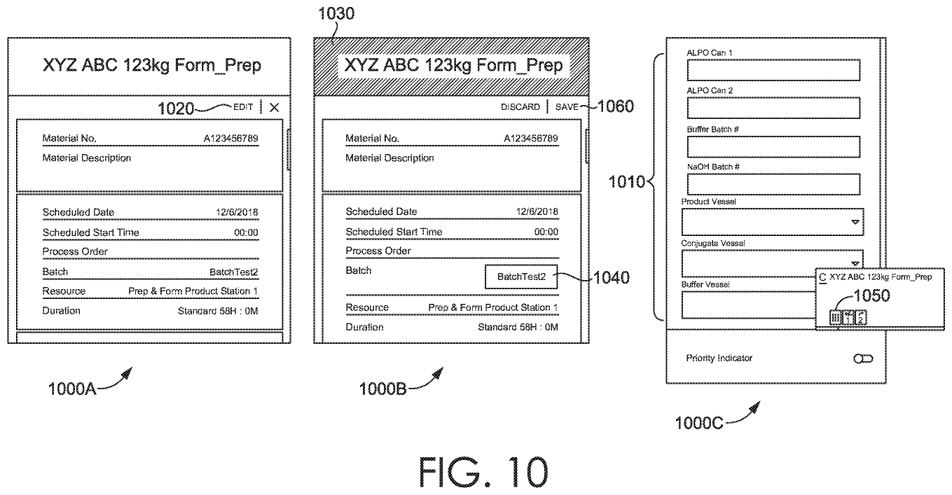

FIG. 10 depicts illustrations of exemplary role card modifying GUIs 1000A, 1000B, 1000C, any of which can be generated by a role card modifying component, such as role card modifying component 338 of FIG. 3. By way of non-limiting example, a first role card modifying GUI 1000A can be generated and provided for display based on a detected interaction with one of the role card objects presented in a standard workflow GUI. The first role card modifying GUI 1000A can present any set of data associated with the role card object and further present an edit GUI element 1020. A detected interaction with the edit GUI element 1020 can cause the generation and presentation of a second role card modifying GUI 1000B. In some aspects, a header portion 1030 of the second role card modifying GUI 1000B can change color to indicate that the edit GUI element 1020 was interacted with. In various embodiments, one or more of the associated data fields, such as data field 1040, can be modified based on inputs received from the client device. The second role card modifying GUI 1000B can further present a save GUI element 1060 that can cause the storing of the modified role card object based on a detected interaction therewith. In some embodiments, any set of custom and editable data fields 1010 can be associated with a role card object of a generated workflow dataset. In this regard, a third role card modifying GUI 1000C is depicted, showing additional data fields 1010 that can be modified based on corresponding inputs received therein. In some aspects, a role card object can be associated with a priority indicator GUI element 1050 that can also be modified via the third role card modifying GUI 1000C.

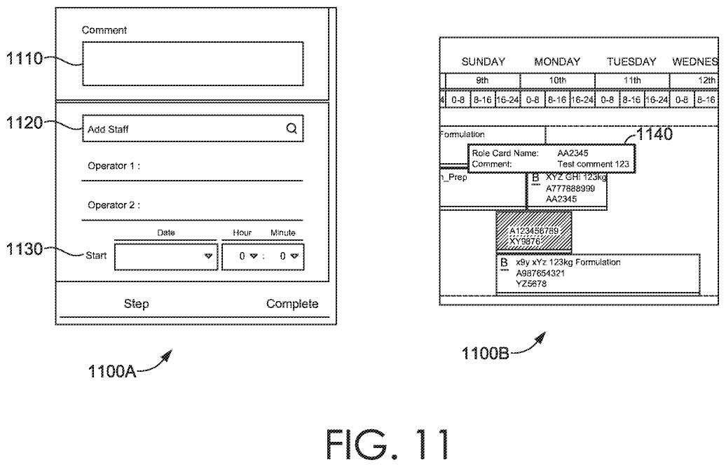

FIG. 11 depicts illustrations of further exemplary role card modifying GUIs 1100A, 1100B, any of which can be generated by a role card modifying component, such as role card modifying component 338 of FIG. 3. By way of non-limiting example, a role card modifying GUI 1100A can be generated and provided for display based on a detected interaction with one of the role card objects presented in a standard workflow GUI. The role card modifying GUI 1100A can further present a comment box 1110 for storing editable comments on progress or other aspects of the role card object. The role card modifying GUI 1100A can further present an “add staff” data field 1120 for assigning users (e.g., colleagues) to the corresponding role card object. Moreover, a “start time” data field 1130 can be presented for defining a date and/or start time for association with the corresponding role card object. In some embodiments, based on the addition of a comment provided via the comment box 1110 and stored within the corresponding role card object, the role card object 1140 presented via the standard workflow GUI can be updated to further present at least a portion of the stored comment (e.g., “Test comment 123”).

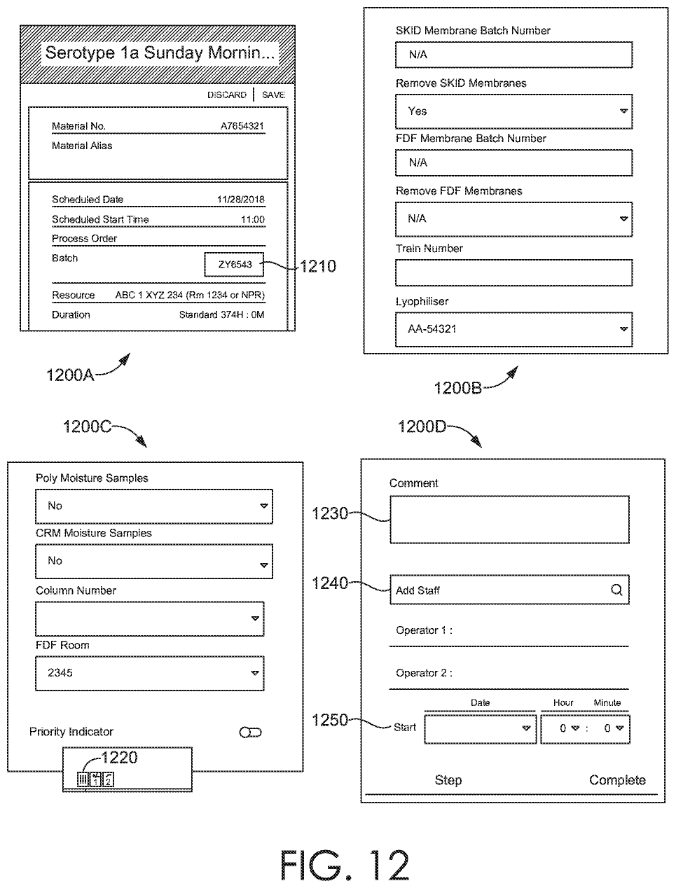

FIG. 12 depicts illustrations of an exemplary set of data fields that can be added to and/or modified in association with a role card object, in accordance with some embodiments of the present disclosure. The following illustrations are merely provided as examples, and are not intended to be limiting. The depicted role card modifying GUIs 1200A, 1200B, 1200C, 1200D can include editable fields such as a batch identifier 1210 (e.g., product), ecosystem-specific fields (e.g., SKID Membrane Batch Number), priority indicator designation 1220, comment box 1230, user assignment 1240, and start date/time 1250, by way of non-limiting example.

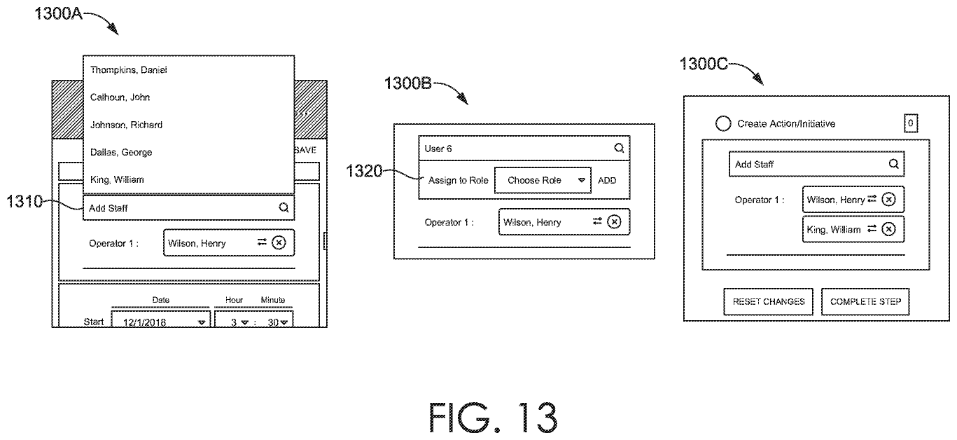

FIG. 13 depicts illustrations of role card modifying GUIs 1300A, 1300B, 1300C, any of which can be generated and provided for display (e.g., by role card modifying component 338) to facilitate the assigning of users to a role card object. In some embodiments, a role card modifying GUI can be generated by a component of the standard work component 310 of FIG. 3 (e.g., role card generating component 336, role card modifying component 338). By way of non-limiting example, a detected interaction (e.g., mouse click, gesture, verbal cue, optical input) with the “add staff” data field 1310 of a role card modifying GUI 1300A can cause a list of available colleagues (e.g., users) to be presented. A user can thus select one of the listed available colleagues via the client device, such that the selected colleague is populated into the “add staff” data field, as depicted in role card modifying GUI 1300B. The selected colleague can further be assigned to a specific role object of a set of role objects included in the presented workflow dataset. In other words, a detected interaction with an “assign to role” data field 1320 can cause a list of role card objects included in the presented workflow dataset to be presented, such that the selected role card object is populated in the “assign to role” data field 1320. Role card modifying GUI 1300C depicts a user and a role card object, each selected for assignment of the user to the role card object. To this end, a detected interaction with a save GUI element, such as the depicted “complete step” element, can cause the role card modifying component to store an association between the selected user and the selected role card object.

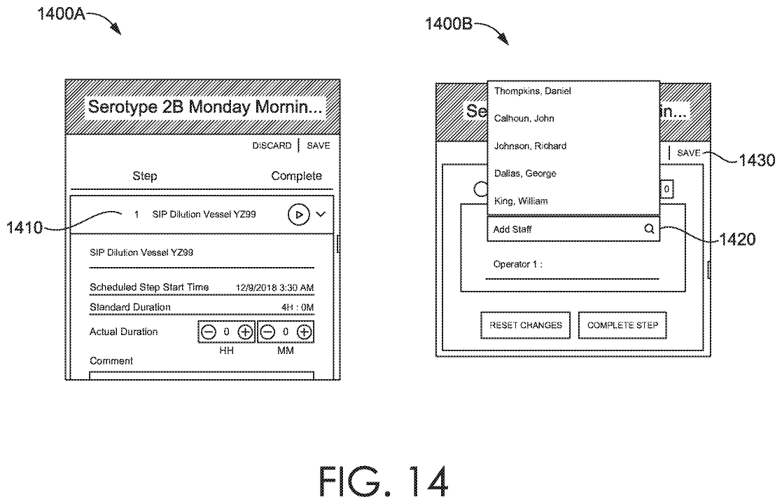

FIG. 14 depicts illustrations of role card modifying GUIs 1400A, 1400B, any of which can be generated and provided for display (e.g., by role card modifying component 338) to facilitate the assigning of users to one or more tasks of a role card object. By way of non-limiting example, a role card modifying GUI 1400A can be generated and provided for display based on a detected interaction (e.g., mouse click, gesture, verbal cue, optical input) with one of the role card objects presented in a standard workflow GUI. The role card modifying GUI 1400A can further present a set of defined tasks (e.g., task 1410) associated with the role card object. In some embodiments, each task or “step” can be edited in an edit mode, such that data fields associated with the task can be modified. The data fields can include an “add staff” data field 1420 that can be populated with a user selected from a set of available users as depicted in role card modifying GUI 1400B. A detected interaction with a “save” GUI element of the role card modifying GUI 1400B can thus cause the role card modifying component to store the role card object with an association between the modified task and the selected user.

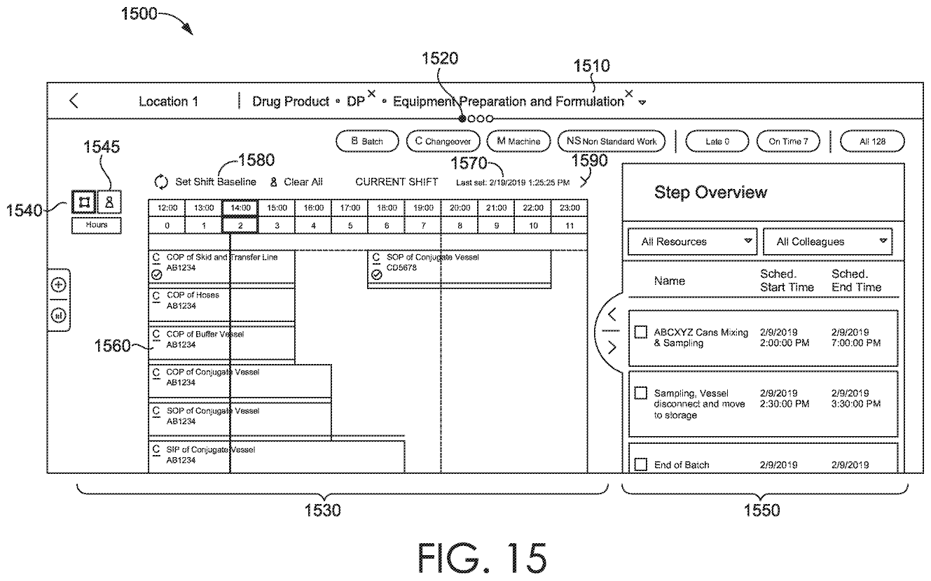

FIG. 15 depicts an illustration of an exemplary shift view GUI 1500, such as one generated by the workflow shift assigning component 350 of FIG. 3. In some embodiments, the shift view GUI 1500 can be provided for display based on a selected set of variables 1510, such as a location and/or date. In some aspects, a role or role tier associated with the client device can further be employed to determine access to the shift view GUI 1500. In some aspects, the shift view GUI 1500 can be selectively presented based on a detected interaction with a selected view 1520 of the standard workflow GUI. The shift view GUI 1500 can include a first portion 1530 that presents one or more tasks assigned to corresponding users, colleagues, machines, equipment, and the like, during a defined period of time or “shift” (e.g., 12-hour shift). In some aspects, a set of GUI elements (e.g., GUI elements 1540, 1545) can be presented to filter the shift view GUI 1500 to include only a list of tasks assigned to machines/equipment (e.g., GUI element 1540) or users/colleagues (e.g., GUI element 1545), among other things. The shift view GUI 1500 can further include a second portion 1550 that presents every task associated with the defined period of time or shift, which can also be filtered based on a selected filtering element (e.g., GUI element 1540). Each task can be listed with a corresponding title, scheduled start time, and/or scheduled end time, among other things associated with the task. In some embodiments, the first portion 1530 of the shift view GUI 1500 can present a listing of time blocks, such as time block 1560, whereby each time block can visually represent a single task of a corresponding role card object. Each block's associated standard duration can also be visually represented utilizing a size (e.g., width or length) of the block, by way of example. In some further embodiments, each block's actual duration can be presented with a corresponding progress bar. In some aspects, each task can be colored or associated with an indicator (e.g., icon) that visually represents a status of the task (e.g., not started, in-progress, complete).

In some embodiments, a user can facilitate a shift handover, or in other words, define a shift start time at which assigned tasks, such as tasks that are associated with a not started, incomplete, and/or in-progress status, are to be reassigned to a different set of users and/or machines. To this end, the shift view GUI 1500 can present a “set shift baseline” GUI element 1580, that when interacted with (e.g., clicked, touched, activated) via the client device, can receive a provided shift start time and an instruction to define the shift start time. The provided shift start time and instruction can be communicated to the workflow shift assigning component 350, which can redefine a new start time for all role card objects and/or tasks determined associated with a not started, incomplete, and/or in-progress status, in accordance with the provided shift start time. In some aspects, any tasks that are determined not started, incomplete, and/or in-progress can be dynamically rescheduled (e.g., associated with the provided shift start time) in response to the received instruction and provided shift start time. In some embodiments, the shift view GUI 1500 can further present a set of navigation GUI elements, such as carrot GUI element 1590, that can facilitate the navigation between shifts presented via the shift view GUI 1500 (e.g., from a currently presented shift to a future shift or prior shift). In accordance with various embodiments, it is contemplated that the definition of a shift start time can facilitate, among other things, the modification and storage of tasks included in role card objects of a workflow dataset.

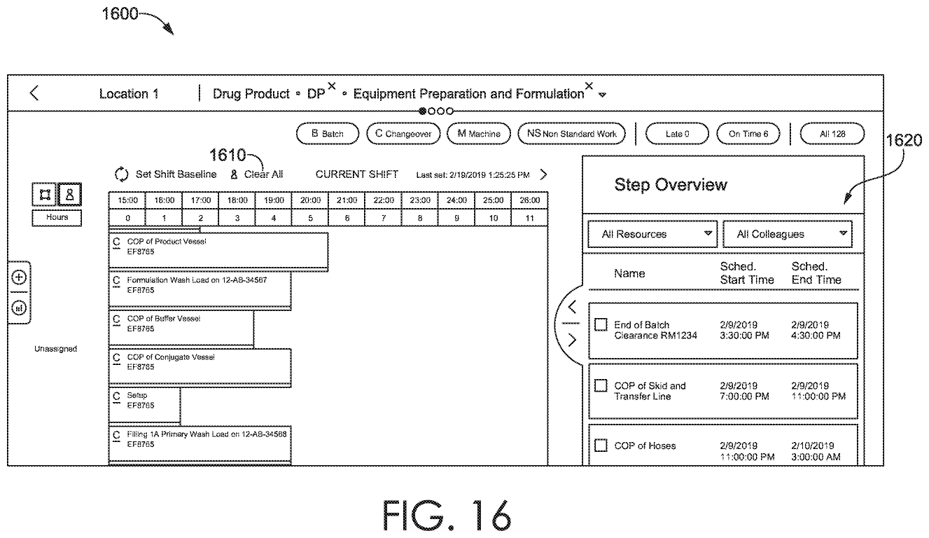

FIG. 16 depicts an illustration of another exemplary shift view GUI 1600, such as one generated by the workflow shift assigning component 350 of FIG. 3. In some embodiments, the shift view GUI 1600 can further present a “clear all” GUI element 1610, that when interacted with via the client device, can receive an instruction to remove all task assignments. In some aspects, the instruction can remove task assignments for the listed tasks for a defined period of time (e.g., 10 days past, 12 hours into the future). The received instruction can be communicated to the workflow shift assigning component 350, which can remove all assignments associated with the listed tasks within the defined period of time. In some aspects, the shift view GUI 1600 can dynamically update each of the listed tasks, such that the tasks appear as being unassigned. To this end, a user could navigate to the second portion 1620 of the shift view GUI 1600, and interact with any one of the listed tasks to edit (e.g., assign) them as desired.

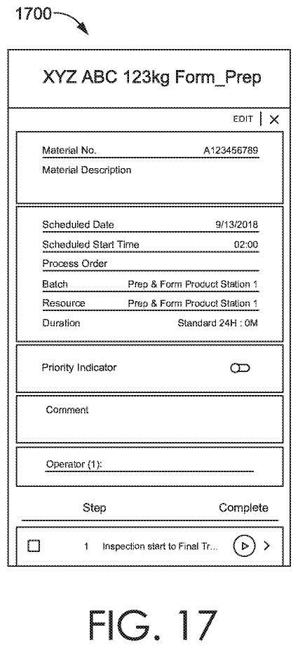

In some aspects, a detected interaction with a task in the second portion 1620 of the shift view GUI 1600 can cause the presentation of an edit task GUI, employable to selectively modify one or more input fields or data values associated with the task. Depicted in FIG. 17 is an exemplary edit task GUI 1700 that can be presented based on a detected interaction with a task listed in the second portion 1620 of the shift view GUI 1600. Similar to a role card modifying GUI generated by the role card modifying component 338 of FIG. 3, the depicted edit task GUI 1700 can include input fields or data fields that can be modified based on corresponding user inputs.

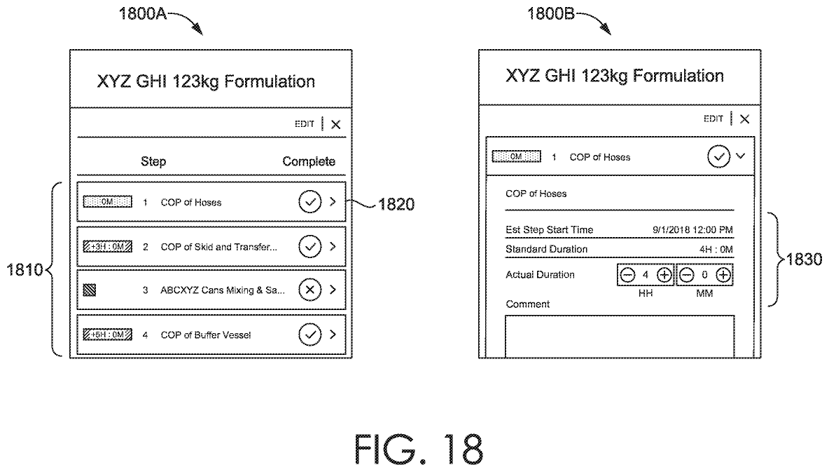

FIG. 18 depicts an illustration of exemplary role card modifying GUIs 1800A, 1800B, such as one generated by the role card modifying component 338 of FIG. 3. In some embodiments, the role card modifying GUI 1800A, 1800B can be provided for display based on a role card object presented via a standard work flow GUI being selected based on user input, by way of example. The role card modifying GUI 1800A can present, among other things, a listing of tasks 1810 defined within the role card object. Based on a detected selection of one of the listed tasks 1810, such as task 1820, an expanded or more detailed role card modifying GUI 1800B can be presented, which includes detailed information and data fields associated with the selected task. In this way, a client device can be employed to edit any one or more of the presented fields, such as fields 1830.

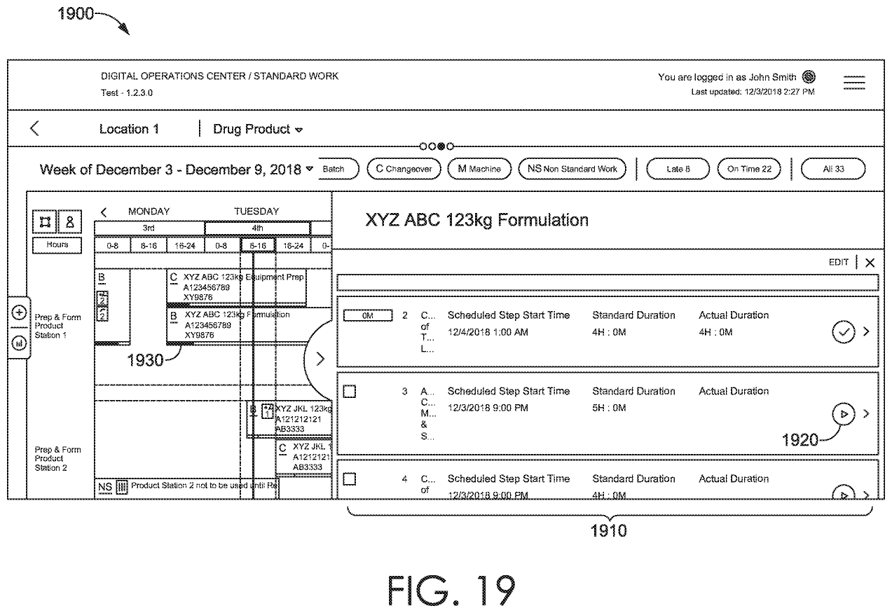

FIG. 19 depicts an illustration of an exemplary standard workflow GUI 1900 including an exemplary role card executing GUI 1910, such as one generated by the role card executing component 340 of FIG. 3. In some embodiments, the role card executing GUI 1910 can be provided for display based on a role card object presented via a standard work flow GUI being selected based on user input, by way of example. The role card executing GUI 1910 can present, among other things, a listing of tasks defined within the role card object, in addition to scheduled start times, status, and other data associated with the role card object and/or tasks. Each of the listed tasks can present a corresponding status indicator, such as status indicator 1920. In some aspects, if a task is complete, the task can present a corresponding indicator to indicate its completed status, such as a check mark. If the task is in progress, the task can present a corresponding indicator to indicate its in-progress status, such as an X. However, if the task is yet to be started, the task can present a corresponding indicator to indicate the not started status, such as a play button 1920. A detected interaction with the play button 1920 can cause the initiation of a timer associated with the task, as described in accordance with the role card executing component 340 of FIG. 3. In this regard, the status of the task can be dynamically updated to in-progress. In some aspects, a real-time progress bar 1930 corresponding to each task or role card object can also be presented via the standard workflow GUI 1900.

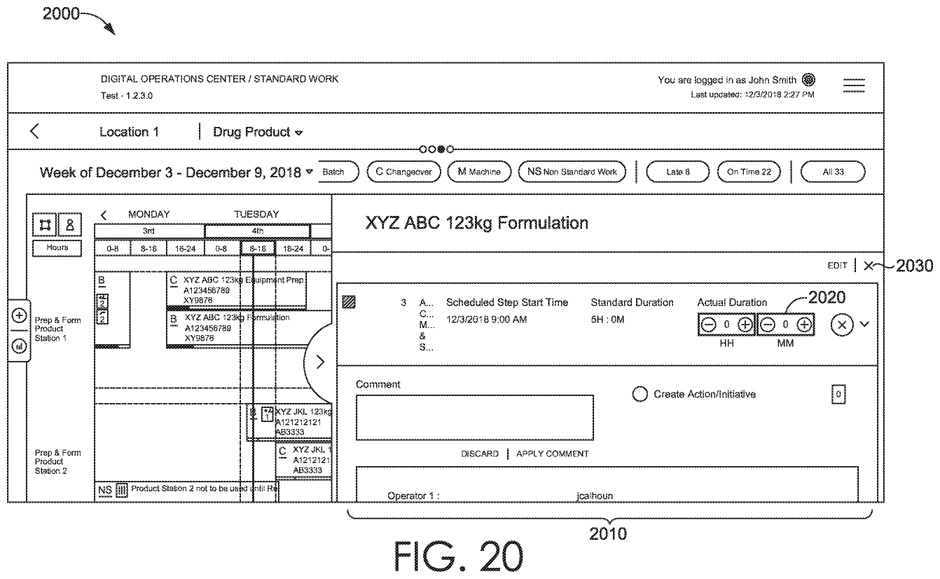

FIG. 20 depicts an illustration of an exemplary standard workflow GUI 2000 including another exemplary role card executing GUI 2010, or an expanded instance of a role card executing GUI (e.g., role card executing GUI 1910 of FIG. 19) after an interaction with one of the tasks is detected. In some embodiments, the role card executing GUI 2010 can present an actual duration field 2020 that corresponds to the actual duration associated with the task. If the task status is in-progress, the actual duration data field 2020 can be populated with values from the associated timer. That is, the hour (HH) and minute (MM) fields can be updated in real-time to show values of the associated timer as the actual duration progresses. In some aspects, the actual duration timer can be manually overridden based on one or more detected interactions with increase (+) or decrease (−) icons associated with the actual duration field 2020. In some embodiments, a detected interaction with one of the icons for manually overriding the actual duration timer can cause the timer to stop so that a manually-defined actual duration can be associated with the task.

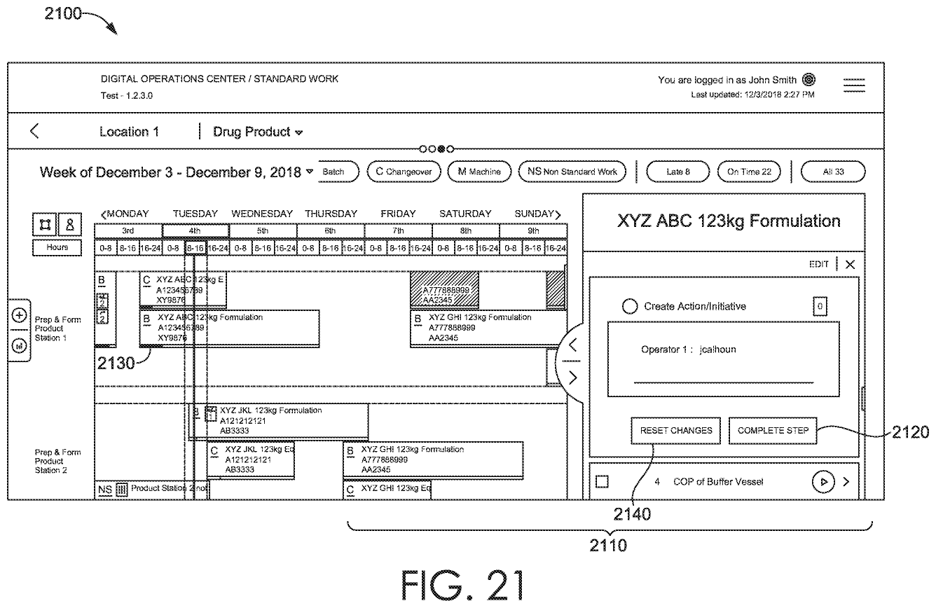

FIG. 21 depicts an illustration of an exemplary standard workflow GUI 2100 including another exemplary role card executing GUI 2110, or a lower portion of an expanded role card executing GUI (e.g., role card executing GUI 2010 of FIG. 20). In some embodiments, the role card executing GUI 2110 can present a complete task or a complete role card GUI element 2120 that can generate an instruction to mark a corresponding task or role card object as complete based on a detected interaction therewith. Based on receipt of the generated instruction, the role card executing component can modify the status associated with the task or role card object. As depicted in the standard workflow GUI 2100, each task or role card can be associated with a corresponding progress bar 2130 that indicates a real-time progression of the task or role card. In some embodiments, based on a received instruction to mark a task or role card object as complete (e.g., via complete role card GUI element 2120), the corresponding progress bar 2130 can also dynamically update to a fully progressed (e.g., filled) state. In some further embodiments, the role card executing GUI 2110 can further present a reset changes GUI element 2140 that can generate an instruction to reset or clear out any information that was captured for the corresponding task or role card object. In this regard, all data fields associated with the task or role card can be effectively deleted.

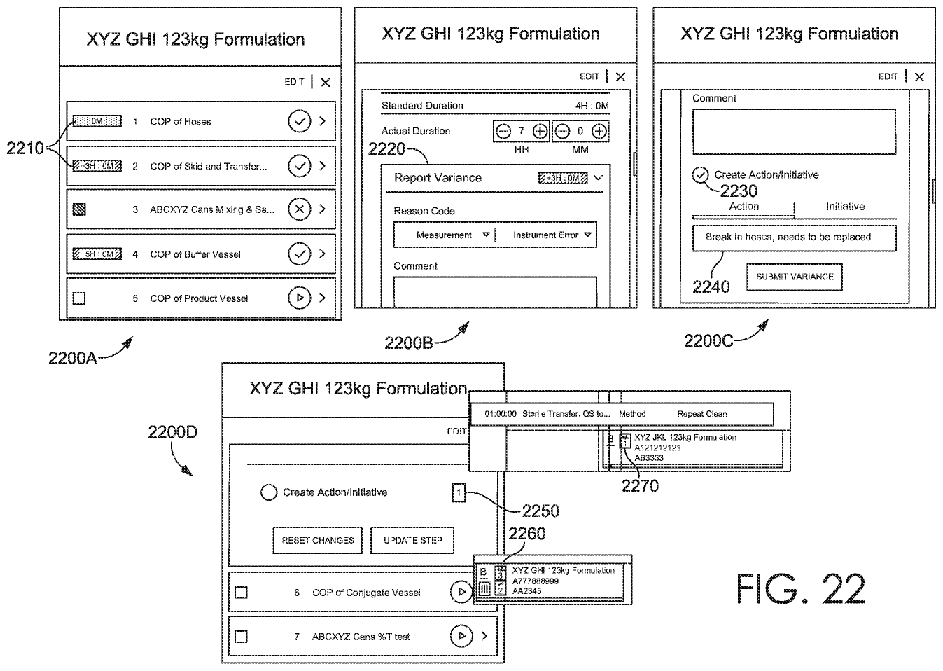

FIG. 22 depicts illustrations of further exemplary role card executing GUIs 2200A-2200D, or further aspects of an expanded role card executing GUI (e.g., an expanded instance of role card executing GUI 2010 of FIG. 20). In some embodiments, a role card executing GUI 2200A presenting a listing of tasks, such as the tasks listed in the role card executing GUI 1910 of FIG. 19, can each present a corresponding variance calculated against a standard duration associated with the task. In some aspects, the corresponding variance can be associated with a corresponding color to indicate whether the calculated variance is within a defined variance threshold, as described in accordance with role card executing component 340 of FIG. 3. In some embodiments, an expanded role card executing GUI 2200B can include a variance comment GUI 2220 that can be employed to receive an explanation associated with the calculated variance. Among other things, the expanded role card executing GUI 2200B can present a set of input fields for including the explanation, reason codes, and/or uploading media (e.g., images, videos, drawings, recordings), among other things. A lower portion of the variance comment GUI presented by expanded role card executing GUI 2200C can further include a create action/initiative GUI element 2230 that can be interacted with to facilitate the generation of an action/initiative dataset associated with the calculated variance, and thereby the task or role card object. A detected interaction with the create action/initiative GUI element 2230 can cause the expansion of an action/initiative comment box for receiving commentary for association with an action/initiative dataset to be generated. Based on a received submission of the information provided via the variance comment GUI 2220, the provided information can be stored to the data store in association with the calculated variance. Provided that an associated action/initiative dataset is to be generated, an action/initiative dataset can further be generated based on the received submission, as described herein.

In some further embodiments, adjacent to a create action/initiative GUI element 2230 as depicted in the lower portion of the variance comment GUI presented by expanded role card executing GUI 2200C, a number GUI element 2250 can be presented as depicted in 2200D, indicating a number of action/initiative datasets created in association with the task or role card object. In accordance with various embodiments, another number GUI element 2260, indicating a calculated total number of calculated variances determined to exceed the defined threshold variance in association with a role card or tasks therein, can be presented corresponding to the role card object presented within a GUI, such as the standard workflow GUI. In some aspects, a detected interaction (e.g., click, hover, mouse over) with a number GUI element 2270, such as number GUI elements 2250, 2260, can cause dynamic display of a pop-up including the calculated variance, task, and any other relevant information (e.g., commentary, reason code, title).

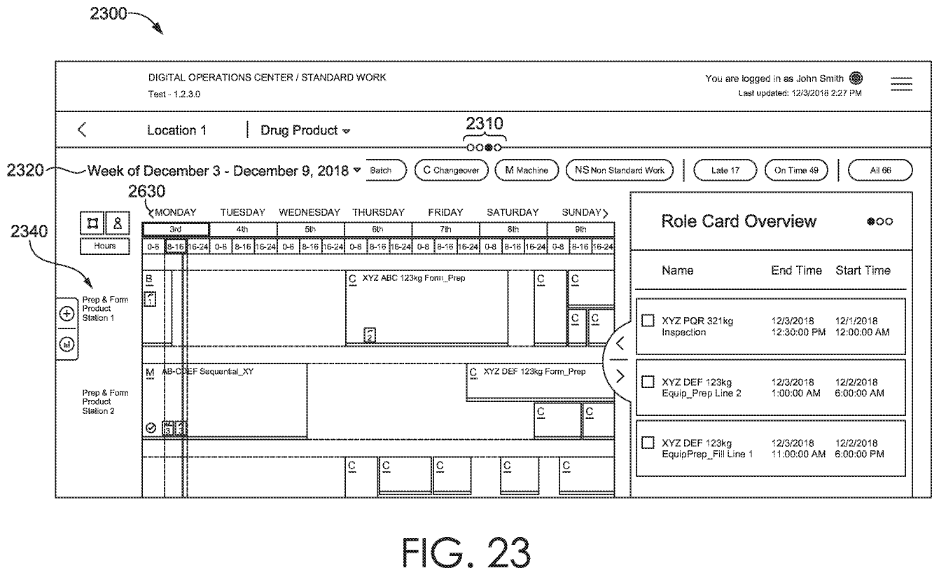

Looking now to FIGS. 23-34, various illustrations are provided depicting exemplary graphical user interface (GUI) implementations for interacting with a visual management component, such as visual management component 410 of FIG. 4. The various illustrations are provided merely as exemplary depictions, and are not intended to be limiting. It is contemplated that any of the GUIs can include alternative GUI elements, titles, content, layouts, and other visual features not depicted in the figures. In accordance with various embodiments, any of the presented GUI elements can be interacted with, such that a client device (e.g., client device 140A, 140B, or 140C of FIG. 1) can detect the interaction and generate a corresponding instruction for communication to a digital operations system 210 or component thereof.

FIG. 23 depicts an illustration of an aspect of an exemplary visual management GUI 2300, such as one generated by the visual management component 410 of FIG. 4. Depicted in the visual management GUI 2300 is a generated standard workflow GUI, such as one generated by the standard work component 310 of FIG. 3. It is contemplated that the visual management GUI 2300 can present various GUIs generated by the visual management component 410, the standard work component 310, or components thereof, in accordance with various embodiments described herein. In some embodiments, similar features and/or operations can be provided by a standard workflow GUI and a visual management GUI. In some aspects, the visual management GUI 2300 can include a view selection GUI element 2310 that facilitates a change between various views (e.g., GUIs, data/dataset filters). In some embodiments, the visual management GUI 2300 can be accessed via the visual management component 410, whereby the access privileges are limited based on user account and/or associated roles, among other things.

As similarly described in accordance with various implementations of the standard workflow GUI, the visual management GUI 2300 can include a time period filtering GUI element 2320 that facilitates the selection of a range of dates. The selected range of dates can be employed to filter a set of role card objects that are scheduled (e.g., having associated start dates/times) as starting and/or ending within the selected range of dates. In some aspects, the visual management GUI 2300 can include one or more plan navigating icons 2330 that facilitate a forward or backward movement in the selected range of dates, for viewing additional role card objects that may be scheduled prior to or after the presented date range. In some further aspects, the visual management GUI 2300 can include a listing of resources, such as resource 2340, that defines a row in which any scheduled tasks or role card objects associated with the resource are in visual alignment with.

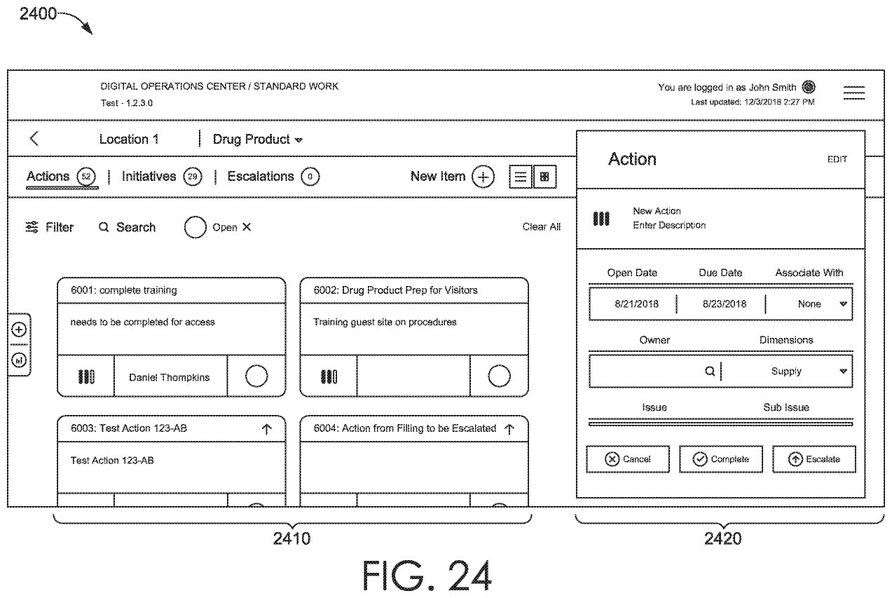

FIG. 24 depicts an illustration of another aspect of an exemplary visual management GUI 2400, such as one generated by the visual management component 410 of FIG. 4. In some embodiments, visual management GUI 2400 can present a listing 2410 of one or more action/initiative datasets stored in a data store, such as data store 135 of FIG. 1. In some aspects, only the action/initiative datasets associated with a user account, role, or role tier of the client device accessing the visual management component can be presented via the visual management GUI 2400. In some further embodiments, the visual management GUI 2400 can further present an action/initiative generating GUI 2420, such as one generated by action/initiative generating component 420 of FIG. 4.

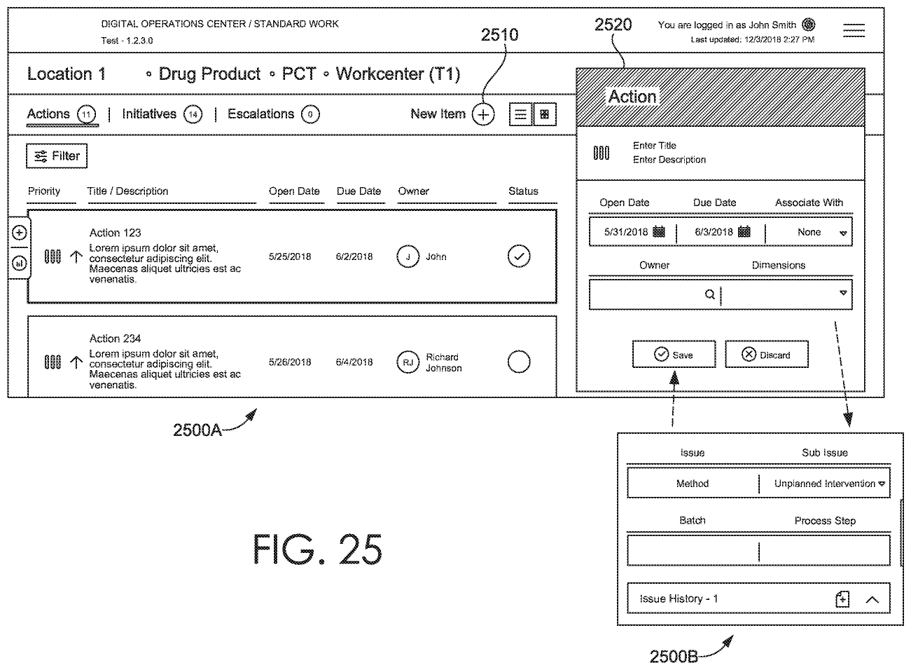

FIG. 25 depicts an illustration of further aspects of an exemplary visual management GUI 2500. In some embodiments, the visual management GUI 2500 can include an add action/initiative GUI element 2510 that can cause display of the action/initiative generating GUI 2520 based on a detected interaction therewith. In some embodiments, the action/initiative generating GUI 2520 can include one or more input fields for providing electronic information for stored association with a new action/initiative dataset to be generated. The input fields can include fields for providing a title, a priority level, a description, an open date (e.g., date of creation or start), a due date, one or more users or user accounts, and/or dimension, among other things. In some embodiments, a detected interaction with a dimension data field can cause display of additional data fields 2500B that can correspond to a type of issue for which an action or initiative dataset is to be generated, such as safety, quality, supply, financials, or people/personnel, among other things. As described herein, based on a received “save” instruction, an action/initiative generating component, such as action/initiative generating component 420 of FIG. 4, can responsively generate and store an action/initiative dataset having associated data corresponding to the populated input fields.

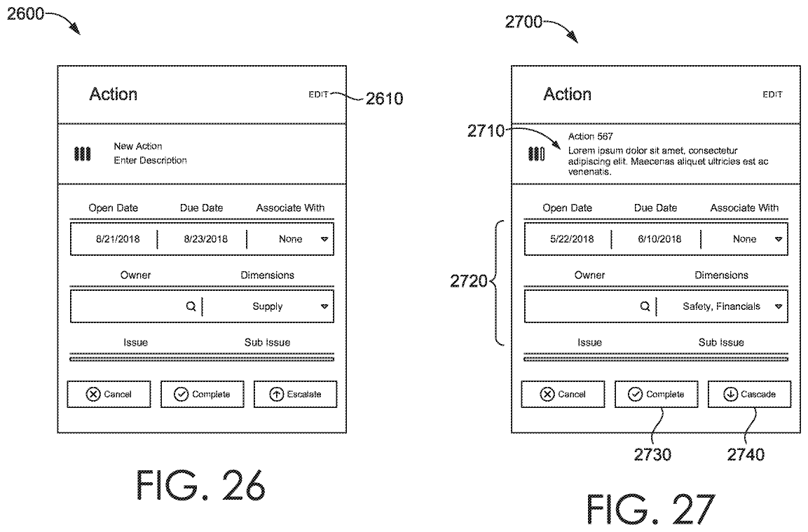

FIG. 26 depicts an illustration of an exemplary action/initiative modifying GUI 2600, such as one generated by action/initiative modifying component 430 of FIG. 4. In some embodiments, the action/initiative modifying GUI 2600 can include an edit GUI element 2610 that can generate a “modify action/initiative” instruction and cause display of a modifiable view of input fields associated with a corresponding action/initiative dataset based on a detected interaction therewith. In some other embodiments, the modifiable view can be displayed based solely on a detected interaction with a stored action/initiative dataset, whereby the edit GUI element 2610 causes storage of the modified action/initiative dataset to the data store.

FIG. 27 depicts an illustration of another aspect of an exemplary action/initiative modifying GUI 2700, such as one generated by action/initiative modifying component 430 of FIG. 4. In some embodiments, the action/initiative modifying GUI 2700 can present the various data fields associated with a stored action/initiative dataset, such as a title and/or description 2710, or other relevant information 2720, (e.g., priority level, description, open date, due date, user accounts, dimension). In accordance with some embodiments, the action/initiative modifying GUI 2700 can further include a “complete” GUI element 2730 that can generate a “complete” instruction for modifying the corresponding action/initiative dataset with a completed state based on a detected interaction therewith. In accordance with some further embodiments, the action/initiative modifying GUI 2700 can further include a “reassign” GUI element, such as the cascade GUI element 2740 depicted in FIG. 27. As described, the type of “reassign” GUI element can differ based on a role or role tier associated with the accessing client device. A detected interaction with the “reassign” GUI element can thus cause the reassignment or added association of the corresponding action/initiative dataset with one or more user accounts of a higher or lower role or role tier, as described in accordance with the action/initiative modifying component 430 of FIG. 4.

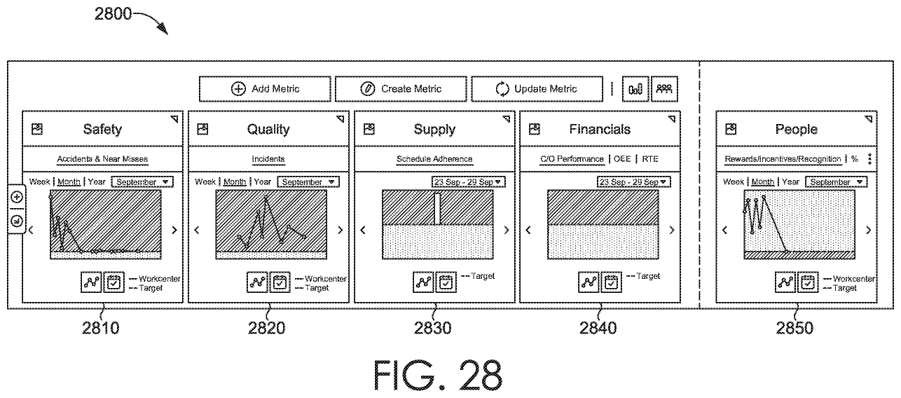

FIG. 28 depicts an illustration of another aspect of an exemplary visual management GUI, such as one generated by visual management component 410 of FIG. 4. In some embodiments, the visual management GUI can present a set of metric GUIs 2800 that present stored metrics data, whether manually or automatically defined. In some embodiments, each metric GUI 2800 can include a corresponding set of metric data that is relevant to an organization or the operations thereof. Depicted in FIG. 28 are some example metric GUIs 2800, including one for safety 2810, quality 2820, supply 2830, financials 2840, and people 2850. It is contemplated that due to access privileges, certain metric GUIs (e.g., people 2850), may be excluded from inclusion based on the role or role tier associated with the accessing client device.

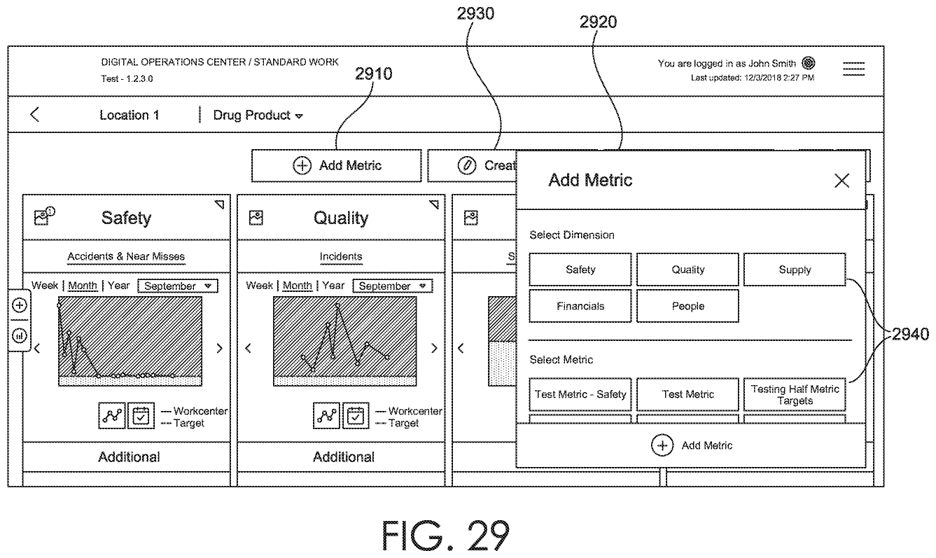

FIG. 29 depicts an illustration of another aspect of an exemplary visual management GUI, such as one generated by visual management component 410 of FIG. 4. In some embodiments, the visual management GUI can present an “add metric” GUI element 2910 that can cause the display of a metrics generating GUI 2920, as described in accordance with the metrics generating component 450 of FIG. 4. The metrics generating GUI 2920 can present a set of dimensions and corresponding metrics data 2940 that can be calculated for inclusion in a metrics GUI to be generated. In some aspects, the metrics data can be calculated based on a selected time frame, location, or any other filtering variable that may be provided via the metrics generating GUI 2920 or similar GUI (e.g., a metrics modifying GUI). A submission of a save instruction, such as an interaction with a “save” GUI element (not shown), can thus cause the generation and storage of a resulting metrics GUI, and a subsequent display thereof to the visual management GUI. In some aspects, custom metrics GUIs can be created to reflect metrics data that is not determined based on a corresponding formula or predefined calculation. In this regard, the visual management GUI can present alternative options, such as a “create metrics” GUI element 2930 to facilitate the generation of customizable metrics GUIs and/or formulas associated therewith.

With brief reference back to the digital operations system 210 of FIG. 2, the connected plant component 240, continuous improvement (CI) loop component 250, structured GEMBA component 260, total productive maintenance (TPM) component 270, and analytics component 280, can each provide additional features and operations that can be accessed by a client device, such as client devices 140A, 140B, 140C of FIG. 1. Any of the connected plant component 240, continuous improvement (CI) loop component 250, structured GEMBA component 260, total productive maintenance (TPM) component 270, and analytics component 280 can generate and provide for display a corresponding set of GUIs and/or GUI elements, to the client device to facilitate a corresponding set of operations.

In some embodiments, the connected plant component 240 can receive, from a plurality of plant sensors, such as sensors 150A-150C of FIG. 1, corresponding pieces of plant data that are relevant to the operational (e.g., production, manufacturing, maintenance, management, testing, development) processes of an organization. In some aspects, each sensor can be associated with a corresponding sensor identifier, such that each piece of plant data generated thereby can be associated with the corresponding sensor identifier. In this regard, a piece of plant data can be identified as originating from a sensor located in a particular location. Similarly, each piece of generated plant data can be associated with a timestamp that identifies a time that the plant data was generated by the sensor. In this way, a time and/or date of generation can easily be identified from the received pieces of plant data. In accordance with various embodiments, the connected plant component 240 can associate the received pieces of plant data with any of the data or datasets stored in a data store, such as data store 135. In other words, each piece of plant data can be associated with a particular workflow dataset, role card object, and/or task defined therein. It is contemplated that in some embodiments, particular resources (e.g., machines, equipment) can have a defined association with particular sensor identifiers, such that associations between tasks associated with such resources can be tracked. It is further contemplated that location information (e.g., GPS coordinates, wireless beacon identifiers) can be detected by a plant sensor and included in a piece of plant data. To this end, as pieces of plant data are received from various sensors located in various locations (e.g., production, supply, laboratory, maintenance, office locations) of an organization, the digital operations system 210 can facilitate a real-time association and analysis of the received plant data to further facilitate the real-time generation and updating of analytics data (e.g., metrics), among other things.

In some embodiments, the continuous improvement loop component 250 can facilitate the real-time tracking of action/initiative datasets, such as those generated by action/initiative generating component 420 of FIG. 4. In some aspects, the continuous improvement loop component 250 can generate a set of GUIs that facilitate a more detailed viewing of calculated metrics or measurements of one or more generated action/initiative datasets. In some embodiments, certain action/initiative datasets can be promoted (e.g., flagged with a higher designation), such that the continuous improvement loop component 250 can present the promoted action/initiative datasets for a more focused view thereof. In addition to the various features, operations, and GUIs provided by visual management component 410 in association with action/initiative datasets, the continuous improvement loop component 250 can provide features for facilitating the implementation of improvement efforts based on the information included in the promoted action/initiative datasets.

In some embodiments, the structured GEMBA component 260 can facilitate the generation and presentation of GUIs that present, among other things, portions of data or datasets stored in the data store, and defined processes that can be employed during a leadership shop-floor walk of a particular location (e.g., plant). In other words, the structured GEMBA component 260 can generate a set of GUIs that focus on defined processes for a particular user associated with a particular role or role tier. The processes defined and presented via the structured GEMBA component 260 can include a listing of action/initiative datasets associated with the location, real-time data associated with the location, interactive survey forms (e.g., comment boxes, check boxes), and any other operations that can facilitate the user's observation and survey of the corresponding location.

In some embodiments, the total production maintenance component 270 can facilitate the generation and presentation of GUIs that present, among other things, relevant real-time data and defined processes that can be utilized by a user to optimally maintain the health of equipment (e.g., machines). In some aspects, plant data received via sensors (e.g., sensors 150A-150C) located within a plant can be employed to facilitate the presentation of real-time data that is relevant to the user. It is contemplated that the real-time data can be processed in various manners to provide greatest value to the user. For instance, plant data can be employed to determine running time, down time, or service time associated with a particular piece of equipment. In some aspects, the total production maintenance component 270 can generate datasets that store, among other things, maintenance records, tickets and assigned users (e.g., for maintenance operations), maintenance intervals, and any other information that can be relevant to the optimal health and maintenance of equipment utilized in an organization's operations.

In some embodiments, the analytics component 280 can receive data or datasets from any one or more components of the digital operations system 210. It is further contemplated that the analytics component 280 can process and perform a variety of calculations on the received data and/or datasets. In some further embodiments, the analytics component 280 can provide processed results data to any one or more components of the digital operations system 210. In various embodiments, the analytics component 280 can generate analytics or metrics data utilizing predefined functions or other predictive technologies, such as machine learning (e.g., neural networks).

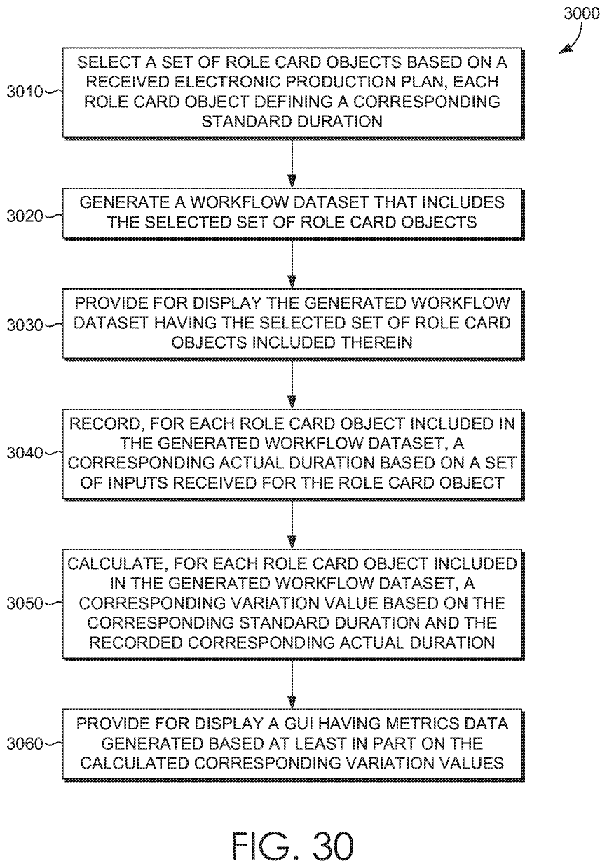

Having described various aspects of the present disclosure, exemplary methods are described below for generating, analyzing, and sharing manufacturing and supply operations data in accordance with lean manufacturing principles, in accordance with various embodiments. Referring to FIG. 30, a flow diagram is provided depicting a method 3000 for dynamically presenting manufacturing and supply operations data in real-time. Each block of method 3000 and other methods described herein comprises a computing process that may be performed using any combination of specialized hardware, firmware, and/or software. For instance, various functions may be carried out by a module, hardware device, or processor executing instructions stored in memory. Various portions of the methods may also be embodied as computer-usable instructions stored on computer storage media.

At block 3010, a standard work component, such as standard work component 310 of FIG. 3, can receive an electronic plan from a client device (e.g., client device 110 of FIG. 1). The electronic plan can include electronic information that defines various manufacturing and supply operations relating to a product. The standard work component can process the electronic plan, parse it into discrete portions (e.g., based on formatting or other tags or identifiers defined therein), and compare each portion to metadata of a plurality of role card objects stored in a data store (e.g., data store 135 of FIG. 1). The standard work component can determine a relevance of each role card object's metadata to a portion of the electronic plan, and in some aspects, determine a confidence value that the role card object's data is a match. In some aspects, a role card object having a highest confidence value for a portion of the electronic plan can be selected for the portion by the standard work component. In various embodiments, each role card object stored in the data store can include a corresponding defined standard duration, and corresponding metadata that can further define a product, resources, location, and other variables described in accordance with various embodiments of the present disclosure.

At block 3020, the standard work component can generate a workflow dataset based on a selected set of role card objects. That is, in accordance with some embodiments, the role card objects determined to have a highest confidence level of matching the various portions of the received electronic plan can be selected for inclusion in a workflow dataset. In some embodiments, at block 3030, the generated workflow dataset can be presented via a standard workflow GUI generated by the standard work component. Each of the role card objects included in the generated workflow dataset can be arranged in association with a calendar or schedule depicted via the standard workflow GUI. In this regard, each selected role card object can be positioned on the standard workflow GUI based on corresponding pieces of information parsed from the electronic plan.

At block 3040, one of the role card objects included in the generated workflow dataset can be interacted with. In other words, a user input (e.g., mouse click, touch or motion gesture, verbal cue) corresponding to one of the role card objects can be received, causing the display of a role card executing GUI. The role card executing GUI can present a set of GUI elements for receiving one or more user inputs that can trigger the initiation (start) and/or termination (stop) of a timer associated with the role card object. In embodiments, the timer can record, in real-time, an actual duration associated with the role card object or tasks thereof. In some aspects, the recorded actual duration associated with the role card object can cause other GUI elements associated with the role card object to be dynamically updated. For instance, a progress bar associated with the role card object can appear and/or dynamically progress as the actual duration increases. In another instance, the progress bar can dynamically move to a completed state (e.g., 100%) if an instruction for completing the tasks associated with the role card object is received.

At block 3050, based on a received instruction to change the role card object to a completed state, the standard work component can calculate a variation value for the role card object. That is, the standard work component can calculate a difference between the standard duration defined by the role card object, and the actual duration recorded based on the one or more received user inputs corresponding to the timer (i.e., the duration between start and stop), to determine the role card object's variation value. In some aspects, the standard work component can compare the calculated difference to a defined variance threshold value. In this way, the standard work component can determine whether some calculated variation values (e.g., exceeding variance threshold) may require further attention, while other calculated variation values (e.g., below variance threshold) may fall within an expected deviation.

At block 3060, the standard work component or a visual management component, such as visual management component 410 of FIG. 4, can generate and provide for display a metrics GUI that presents a set of metrics data calculated based on the calculated variation values of role card objects included in the generated workflow dataset. For instance, some of the metrics data in the set of metrics data can be determined utilizing a sum of the calculated variation values. In some aspects, the set of metrics data can be calculated based only on the calculated variation values that are determined to exceed the defined threshold variation value. For instance, some of the metrics data in the set of metrics data can be determined utilizing a sum of the calculated variation values determined to exceed threshold values. In another instance, a count of the variation values determined to exceed threshold values can be employed to determine some of the metrics data. It is contemplated that counts and sums can be employed to determine a variety of metrics data, such as averages, among other things. In some other aspects, any or all calculated variation values associated with a generated workflow dataset can be employed to calculate the set of metrics data. To this end, the metrics GUI generated and provided for display can be employed to present a real-time depiction of manufacturing and supply operations data that is generated based on variation values calculated in association with role card objects selected for inclusion in a workflow dataset.

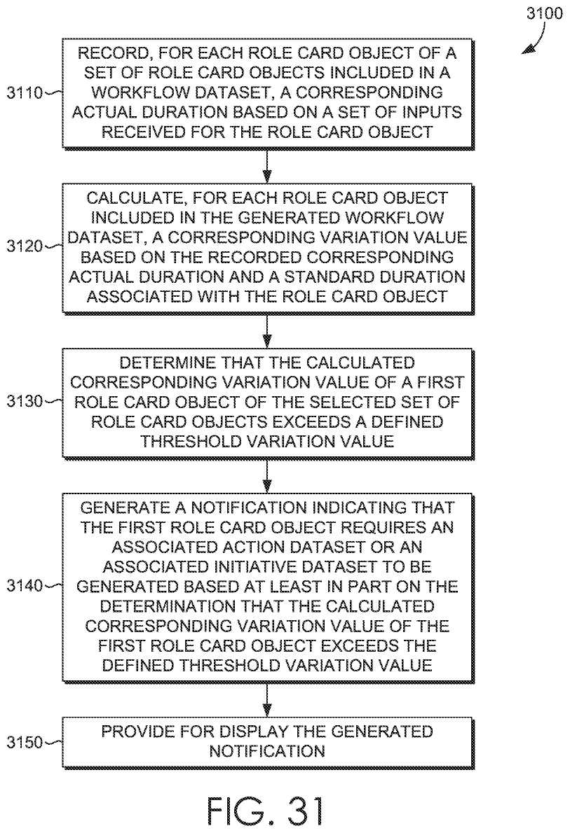

Referring to FIG. 31, a flow diagram is provided depicting a method 3100 for dynamically presenting manufacturing and supply operations data in real-time. Each block of method 3100 and other methods described herein comprises a computing process that may be performed using any combination of specialized hardware, firmware, and/or software. For instance, various functions may be carried out by a module, hardware device, or processor executing instructions stored in memory. Various portions of the methods may also be embodied as computer-usable instructions stored on computer storage media.

In some embodiments and as described in accordance with some blocks of FIG. 30, a standard work component, such as standard work component 310 of FIG. 3, can receive an electronic plan from a client device (e.g., client device 110 of FIG. 1). The electronic plan can include electronic information that defines various manufacturing and supply operations relating to a product. The standard work component can process the electronic plan, parse it into portions (e.g., based on formatting or other tags or identifiers), and compare each portion to metadata of a plurality of role card objects stored in a data store (e.g., data store 135 of FIG. 1). The standard work component can determine a relevance of each compared role card object's metadata to the portion of the electronic plan, and in some aspects, determine a confidence value that the role card object's data is a match. In some aspects, a role card object having a highest confidence value for a portion of the electronic plan can be selected by the standard work component. In various embodiments, each role card object stored in the data store can include a corresponding defined standard duration, and corresponding metadata that can further define a product, resources, location, and other variables described in accordance with various embodiments of the present disclosure.

As also described in accordance with some other blocks of FIG. 30, the standard work component can generate a workflow dataset based on the selected set of role card objects. That is, in accordance with some embodiments, the role card objects determined to have a highest confidence level of matching the various portions of the received electronic plan can be selected for inclusion in a workflow dataset. In some embodiments, at block 3030, the generated workflow dataset can be presented via a standard workflow GUI generated by the standard work component. Each of the role card objects included in the generated workflow dataset can be arranged in association with a calendar or schedule depicted via the standard workflow GUI. In this regard, each selected role card object can be positioned on the standard workflow GUI based on corresponding pieces of information parsed from the electronic plan.

At block 3110, one of the role card objects included in the generated workflow dataset can be interacted with. In other words, a user input corresponding to one of the role card objects can be received, causing the display of a role card executing GUI. The role card executing GUI can present a set of GUI elements for receiving one or more user inputs that can trigger the initiation and/or termination of a timer associated with the role card object. In embodiments, the timer can record, in real-time, an actual duration associated with the role card object or tasks thereof. In some aspects, the recorded actual duration associated with the role card object can cause other GUI elements associated with the role card object to be updated. For instance, a progress bar associated with the role card object can appear and/or progress as the actual duration increases. In another instance, the progress bar can move to a completed state (e.g., 100%) if an instruction for completing the tasks associated with the role card object is received.

At block 3120, based on a received instruction to change the role card object to a completed state, the standard work component can calculate a variation value for the role card object. That is, the standard work component can calculate a difference between the standard duration defined by the role card object, and the actual duration recorded based on the one or more received user inputs corresponding to the timer, to determine the role card object's variation value. At block 3130, the standard work component can compare the calculated difference to a defined variance threshold value. In this way, the standard work component can determine whether some calculated variation values (e.g., exceeding variance threshold) may require further attention, while other calculated variation values (e.g., below variance threshold) may fall within an expected deviation.

At block 3140, the standard work component or a visual management component, such as visual management component 410 of FIG. 4, can generate a notification and/or other GUI, such as a variance comment GUI generated by role card executing component 340 of FIG. 3, indicating that the calculated variation value of a completed role card object exceeds the defined threshold variance value. At block 3150, the generated notification or GUI can be provided for display. In some aspects, the notification or GUI can include a requirement that an action dataset or an initiative dataset, such as one generated by action/initiative generating component 420 of FIG. 4, be generated based on the calculated variation value being determined to exceed the defined threshold variance value.

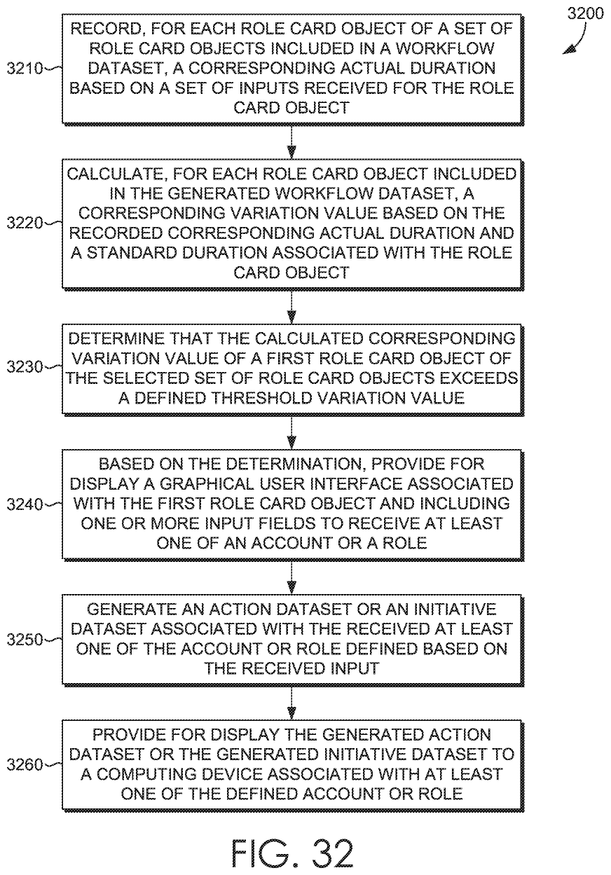

Referring to FIG. 32, a flow diagram is provided depicting a method 3200 for dynamically presenting manufacturing and supply operations data in real-time. Each block of method 3200 and other methods described herein comprises a computing process that may be performed using any combination of hardware, firmware, and/or software. For instance, various functions may be carried out by a module, hardware device, or processor executing instructions stored in memory. Various portions of the methods may also be embodied as computer-usable instructions stored on computer storage media.

In some embodiments and as described in accordance with some blocks of FIG. 30, a standard work component, such as standard work component 310 of FIG. 3, can receive an electronic plan from a client device (e.g., client device 110 of FIG. 1). The electronic plan can include electronic information that defines various manufacturing and supply operations relating to a product. The standard work component can process the electronic plan, parse it into portions (e.g., based on formatting or other tags or identifiers), and compare each portion to metadata of a plurality of role card objects stored in a data store (e.g., data store 135 of FIG. 1). The standard work component can determine a relevance of each compared role card object's metadata to the portion of the electronic plan, and in some aspects, determine a confidence value that the role card object's data is a match. In some aspects, a role card object having a highest confidence value for a portion of the electronic plan can be selected by the standard work component. In various embodiments, each role card object stored in the data store can include a corresponding defined standard duration, and corresponding metadata that can further define a product, resources, location, and other variables described in accordance with various embodiments of the present disclosure.

As also described in accordance with some other blocks of FIG. 30, the standard work component can generate a workflow dataset based on the selected set of role card objects. That is, in accordance with some embodiments, the role card objects determined to have a highest confidence level of matching the various portions of the received electronic plan can be selected for inclusion in a workflow dataset. In some embodiments, at block 3030, the generated workflow dataset can be presented via a standard workflow GUI generated by the standard work component. Each of the role card objects included in the generated workflow dataset can be arranged in association with a calendar or schedule depicted via the standard workflow GUI. In this regard, each selected role card object can be positioned on the standard workflow GUI based on corresponding pieces of information parsed from the electronic plan.

At block 3210, one of the role card objects included in the generated workflow dataset can be interacted with. In other words, a user input corresponding to one of the role card objects can be received, causing the display of a role card executing GUI. The role card executing GUI can present a set of GUI elements for receiving one or more user inputs that can trigger the initiation and/or termination of a timer associated with the role card object. In embodiments, the timer can record, in real-time, an actual duration associated with the role card object or tasks thereof. In some aspects, the recorded actual duration associated with the role card object can cause other GUI elements associated with the role card object to be updated. For instance, a progress bar associated with the role card object can appear and/or progress as the actual duration increases. In another instance, the progress bar can move to a completed state (e.g., 100%) if an instruction for completing the tasks associated with the role card object is received.

At block 3220, based on a received instruction to change the role card object to a completed state, the standard work component can calculate a variation value for the role card object. That is, the standard work component can calculate a difference between the standard duration defined by the role card object, and the actual duration recorded based on the one or more received user inputs corresponding to the timer, to determine the role card object's variation value. At block 3230, the standard work component can compare the calculated difference to a defined variance threshold value. In this way, the standard work component can determine whether some calculated variation values (e.g., exceeding variance threshold) may require further attention, while other calculated variation values (e.g., below variance threshold) may fall within an expected deviation.

At block 3240, the standard work component or a visual management component, such as visual management component 410 of FIG. 4, can generate a GUI, such as a variance comment GUI generated by role card executing component 340 of FIG. 3, indicating that the calculated variation value of a completed role card object exceeds the defined threshold variance value. In some embodiments, the generated notification or GUI can be provided for display. In some aspects, the GUI can include a requirement that an action dataset or an initiative dataset, such as one generated by action/initiative generating component 420 of FIG. 4, be generated based on the calculated variation value being determined to exceed the defined threshold variance value. In some further embodiments, the displayed GUI can include a set of input fields that receive one or more user accounts and/or roles for association with the calculated variation value determined to exceed the defined threshold variance value.

As such, an action/initiative generating component, such as action/initiative generating component 420 of FIG. 4, can receive data values populated within the displayed set of input fields. At block 3250, based on a receipt of the received one or more user accounts and/or roles via the displayed GUI, the action/initiative generating component can generate and store one of a corresponding action dataset or initiative dataset associated with the received user account(s) and/or role(s). In this way, at block 3260, a visual management component, such as visual management component 410 of FIG. 4, can generate a visual management GUI that lists at least the generated action dataset or initiative dataset associated with the user account and/or role. As any of the standard work component or visual management component described herein can limit the accessibility of certain data or datasets to a user account and/or role associated with the data or datasets, it is contemplated that a client device (e.g., client device 140A-140C) accessing the standard work component or visual management component can only be provided with and/or display a listing of action datasets or initiative datasets based on the user account and/or role associated with the client device.

With reference now to FIG. 33, computing device 3300 includes a bus 3310 that directly or indirectly couples the following devices: memory 3312, one or more processors 3314, one or more presentation components 3316, input/output ports 3318, input/output components 3320, and an illustrative power supply 3322. Bus 3310 represents what may be one or more busses (such as an address bus, data bus, or combination thereof). Although the various blocks of FIG. 33 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 33 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 33 and reference to “computing device.”

Computing device 3300 typically includes a variety of computer-readable media. Computer-readable media can be any available media that can be accessed by computing device 3300 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 3300. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 3312 includes computer storage media in the form of volatile and/or nonvolatile memory. The memory may be removable, non-removable, or a combination thereof. Exemplary hardware devices include solid-state memory, hard drives, optical-disc drives, etc. Computing device 3300 includes one or more processors that read data from various entities such as memory 3312 or I/O components 3320. Presentation component(s) 3316 present data indications to a user or other device. Exemplary presentation components include a display device, speaker, printing component, vibrating component, etc.

I/O ports 3318 allow computing device 3300 to be logically coupled to other devices including I/O components 3320, some of which may be built in. Illustrative components include a microphone, joystick, game pad, satellite dish, scanner, printer, wireless device, etc.

For purposes of the detailed description above, some embodiments of the present disclosure are described with reference to a distributed ledger (e.g., blockchain). In accordance with some embodiments, a distributed ledger can be collectively maintained by a network (e.g., a distributed ledger network) of nodes. In accordance with some embodiments, the operation of “storing” any piece or type of electronic data (e.g., electronic plans, workflow datasets, role card objects, tasks, statuses, schedules, accounts, plant data, action datasets, initiative datasets, metrics, standard durations, actual durations, variation values, threshold values) by any one or more of the systems, devices, components, subcomponents, sensors, or modules described herein can be facilitated by employment of any one or more nodes of the distributed ledger network. In some embodiments, any portion of electronic data that is generated, communicated to, and/or received by a node can be encrypted at any time (e.g., before the communication, after it is received). The distributed ledger network can include a plurality of nodes, each node including a computing device described in accordance with FIG. 33, and in operable communication with one or more of the plurality of nodes via a network, such as is described in accordance with network 120 of FIG. 1. In some embodiments, any one or more of the systems (e.g., the digital operations system 210 of FIG. 2), computing devices (e.g., computing device 110, 140A-140C of FIG. 1), servers (e.g., server 115, 130 of FIG. 1), sensors (e.g., sensors 150A-150C of FIG. 1), components (e.g., standard work component 220, visual management component 230, connected plant component 240, CI loop component 250, structured GEMBA component 260, total productive maintenance component 270, analytics component 280 of FIG. 2), and/or subcomponents thereof, described in accordance with the present disclosure, can include a node or perform the functions of a node in a distributed ledger network.

In some embodiments, and preferably for public blockchain implementations, each node in the distributed ledger network can generally operate as a peer to every other node for purposes of maintaining a distributed ledger, such as a blockchain, such that no single node is more influential or powerful than any other node for purposes of maintaining the distributed ledger. Operations performed by nodes can include, among other things, sending and receiving transactions (e.g., electronic data or datasets that include any portion of the electronic data to be stored on an immutable ledger), validating transactions, verifying blocks of transactions, and adding transactions to an immutable ledger (e.g., blockchain) that is collectively maintained by the nodes, a copy of which is respectively stored in a memory of each node. It is contemplated, however, that in some embodiments, a particular subset of the nodes can be specifically designated for performing more operations than other nodes. In this regard, as opposed to some embodiments where each node is an absolute peer with other nodes, other embodiments can employ “privileged nodes” or “unprivileged nodes” (e.g., for private blockchain implementations or ecosystems where centralization is not a concern), such that privileged nodes can perform more operations (e.g., validating, verifying, block generation) than the unprivileged nodes.

In some embodiments, the immutable ledger collectively maintained by the nodes is referenced herein as a blockchain. The blockchain maintained by the distributed ledger network can store thereon a plurality of transactions (e.g., electronic datasets), such as any object or dataset generated by the digital operations system 210 of FIG. 2 or components thereof, which when stored to the blockchain, are immutable by virtue of the distributed nature of the distributed ledger network, applied cryptography concepts, and a consensus ruleset that is independently enforced by each of nodes. In a traditional distributed ledger network (e.g., a public blockchain network), any node can generate a transaction to be added to the blockchain. In a privileged or private distributed ledger network, one or more privileged nodes can generate a transaction to be added to the blockchain. As such, each node can include consensus logic that includes a processor-enforced consensus ruleset, whereby a transaction can only be added to the blockchain based on a determination that a consensus (e.g., a majority, a super majority, unanimity, predefined number, each defined in accordance with the consensus ruleset) of the nodes has collectively validated the transaction. In this regard, while each node can independently receive transactions and store a copy of the blockchain including the transactions, a transaction can only be added to the blockchain when a consensus to add the transaction, as defined by the consensus ruleset, has been determined reached by the nodes of the distributed ledger network.

In some embodiments, validation of a transaction can be facilitated utilizing features of asymmetric key cryptography (i.e., public-private key pairs), among other validation techniques. In some aspects, as is commonly known in public blockchain implementations (e.g., Bitcoin, Ethereum), a private key can be employed to generate one or more associated public keys, encrypt data that can only be decrypted by an associated public key, and/or digitally sign data or transactions. On the other hand, a public key can be employed to decrypt data encrypted by an associated private key, encrypt data that only the private key can decrypt, and/or digitally authenticate a digital signature generated by an associated private key.

In various embodiments, a transaction generated by a node can be communicated from the node to one or more nodes of the distributed ledger network. In other words, a transaction received by a node can be passed on to another node of the distributed ledger network. Similarly, the other node can pass on the received transaction to yet another node of the distributed ledger network. In this regard, a transaction communicated from one node to another node of the distributed ledger network can be passed on to other nodes until the transaction has propagated throughout the entire distributed ledger network. In some embodiments, however, a transaction is not finalized (i.e., added to the blockchain) until the transaction is validated by a consensus of nodes in the distributed ledger network, as defined by the consensus ruleset enforced by the nodes.

In some embodiments, a node can validate a received transaction based on a determination that the transaction has been digitally signed by a known or authorized private key, such as one associated with a privileged node, or one associated with an authorized user account. In some aspects, each node of the distributed ledger network can determine that a transaction was digitally signed with a private key associated with a privileged node based on a provided or identified public key of the privileged node. In some implementations, a public key of the privileged node can be defined in each consensus component, or can be defined on the blockchain to be easily determined by any node of the distributed ledger network. In some other aspects, each node of the distributed ledger network can determine that a transaction was digitally signed with a private key associated with an authorized user account based on the public key of each user account being securely shared (e.g., communicated) between the nodes of the distributed ledger network.

In some embodiments, if a node in the distributed ledger network determines that a transaction is not valid (i.e., is not an authorized transaction), the transaction is determined invalid by the node and the transaction is not passed on (e.g., communicated) to other nodes to which it is in communication with. On the other hand, if a node determines that a transaction is valid (i.e., is signed with an authorized key), the node can pass on (e.g., communicate) the transaction, along with an indication that the node independently validated the transaction, to any other node in communication therewith. As the nodes in the distributed ledger network are directly or indirectly connected to one another, this validation process can continue on until the nodes collectively determine that a consensus of the nodes, as defined by the consensus ruleset, has validated the transaction. In an example, the collective determination of a consensus can be facilitated by virtue of each node maintaining a list of other nodes on the network (e.g., by I.P. address or other identifier) along with their respective determinations of transaction validity.

In some embodiments, after a consensus of validity for a transaction has been reached by the nodes, the transaction can be added to the blockchain maintained and stored by each node. In some embodiments, a validated transaction must await confirmation before it is added to the blockchain. As the nodes can be peers with one another in accordance with public blockchain implementations, as described above, any node can participate in the process of adding the transaction to the blockchain. For purposes of background, a blockchain generally includes validated transactions that are grouped into a cryptographically chained series of blocks, whereby each block includes a subset of these transactions. In some embodiments, any node can perform the process of block generation, which can be implemented in a variety of ways (e.g., consensus mechanisms) based on a consensus ruleset enforced by the consensus component including, but not limited to, proof of work, proof of stake, proof of authority, practical Byzantine Fault Tolerance, or Federated Byzantine Agreements. As the aforementioned consensus mechanisms for block generation are generally known in the art, additional detail for these processes are not described herein. It is contemplated, however, that any implementation of block generation and consensus determination can be employed in accordance with some embodiments of the present disclosure. More importantly, as the general outcome of block generation is relatively similar among various implementations, the following description is provided irrespective of the block generation aspect of the consensus module.

In some embodiments, to add a validated transaction to the blockchain, the transaction must first be included into a block that is being generated by one of the nodes and subsequently validated by a consensus of the nodes in the distributed ledger network. The transaction can be independently included into a block, or grouped together with other transactions, either of which are included within the purview of the present disclosure. Such implementations may vary, however, based on design considerations of the consensus component and/or a block size (i.e., memory limitation) implemented or defined as part of a consensus ruleset enforced by the consensus component of each node. In various embodiments, a node generating a block must also include, into the block it is generating, a cryptographic hash of the block most-recently added to the blockchain. Once generated in accordance with any consensus rules defined by the consensus component, a node generating a block can send the generated block to any of the nodes to which it is in communication with (e.g., via a network).

In some embodiments, nodes receiving the generated block can verify that the block includes one or more valid transactions, includes a hash value of a block most-recently added to the blockchain, and that the block was generated in accordance with the defined consensus ruleset. Upon verifying the foregoing, a node can pass on (e.g., communicate) the verified block to its neighboring node(s), or in other words, one or more nodes it is communication with via the network. In this way, and similar to how a transaction is validated by a determined consensus of the distributed ledger network, a generated block including at least the transaction can be verified by another determined consensus of the nodes. When a determination is made that a consensus of the nodes has verified a block, the newly-verified block is added by each of the nodes to its respective copy of the blockchain immediately subsequent to a previously-added block, the hash of the previously-added block being included into the newly-verified block. In this regard, each block can be cryptographically “chained” to a previous block and a subsequent block. In other words, the cryptographic hashes can immutably enforce the order and accuracy of transactions stored on the blockchain. In some embodiments, each respective copy of the blockchain maintained by a node can be accessed by the node, any other node, or in some further embodiments, a computing device such as client device 110, 140A-140C, or server device 115, 130 of FIG. 1. In this regard, the blockchain can be provided as a transparent record of transactions, that can be cross-referenced in a variety of manners, whether for purposes of auditing, verifying, or simply referencing transactions that have been performed on or in association with any piece of electronic information or data described in accordance with the present disclosure.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of the detailed discussion above, embodiments of the present invention are described with reference to a digital operations system, components, and subcomponents thereof; however, the digital operations system, components, and subcomponents are depicted herein is merely exemplary. Components can be configured for performing novel aspects of embodiments, where configured for comprises programmed to perform particular tasks or implement particular abstract data types using code. Further, while embodiments of the present invention may generally refer to the head-mounted display unit and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

1-15. (canceled)

16. A computer-implemented method comprising:
selecting, by a computing device, a set of stored role card objects determined to correspond to a received electronic plan based on metadata included in each role card of the set of stored role card objects, wherein each role card object of the selected set of stored role card objects defines a corresponding standard duration;
generating, by the computing device, a workflow dataset that includes the selected set of stored role card objects;
providing for display, by the computing device, the generated workflow dataset having the selected set of stored role card objects presented therein;
recording, by the computing device, a corresponding actual duration for each role card object of the presented role card objects based on a corresponding set of inputs received for the role card object;
calculating, by the computing device, a corresponding variation value for each role card object included in the generated workflow dataset based on the defined corresponding standard duration and the recorded corresponding actual duration; and
providing for display, by the computing device, metrics data that is generated based at least in part on the variation values calculated for at least a portion of the role card objects included in the generated workflow dataset.

17. The method of claim 16, wherein the selected set of stored role card objects is arranged in the generated workflow dataset based on the received electronic plan.

18. The method of claim 16, further comprising:
modifying, by the computing device, the generated workflow dataset based on an additional role card object generated based on another set of received inputs; and
providing for display, by the computing device, the modified workflow dataset having the selected set of stored role card objects and the generated additional role card object presented therein.

19. The method of claim 16, further comprising:
providing for display, by the computing device, an input field associated with a particular role card object of the presented role card objects based on determining that the corresponding calculated variance value exceeds a defined threshold variance value; and
storing, by the computing device, an input string received via the displayed input field in association with the particular role card object.

20. The method of claim 19, wherein the metrics data is generated based further in part on the determination that the calculated variance value corresponding to each role card object of at least the portion of the role card objects included in the generated workflow dataset exceeds the defined threshold variance value.

21. The method of claim 19, wherein the presented particular role card object further presents an excessive variance notification generated based at least in part on the detected positive variation value.

22. The method of claim 16, further comprising:
determining, by the computing device, a progress of the generated workflow dataset based on a scheduled start time associated with the generated workflow dataset and one or more recorded actual durations associated with the role card objects included therein.

23. The method of claim 22, wherein the progress is determined based further on the standard durations defined by the role card objects included in the generated workflow dataset.

24. The method of claim 16, wherein the metrics data is generated based further in part on a selected metric criteria.

25. A non-transitory computer storage medium storing computer-useable instructions that, when used by one or more processors, cause the one or more processors to:
select a set of role card objects from a plurality of stored role card objects based on a determination that metadata in each role card object of the set of role card objects corresponds to a portion of a received electronic plan, wherein each role card object of the selected set of role card objects defines a corresponding standard duration;
generate a workflow dataset based on the selected set of role card objects;
for each role card object included in the generated workflow dataset—
record a corresponding actual duration based on a set of inputs received in association with the role card object;
calculate a corresponding variation value based on the defined corresponding standard duration and the recorded corresponding actual duration; and
provide for display a graphical user interface that is generated based on at least a portion of the variation values calculated for the role card objects included in the generated workflow dataset.

26. The medium of claim 25, wherein an order of each role card object included in the generated workflow dataset is defined based on the received electronic plan.

27. The medium of claim 25, wherein the instructions further cause the one or more processors to:
modify the generated workflow dataset based on an additional role card object generated based on another set of received inputs, wherein the modified workflow dataset includes the selected set of role card objects and the generated additional role card object.

28. The medium of claim 27, wherein the additional role card object is not selected based on the received electronic plan.

29. The medium of claim 25, wherein the instructions further cause the one or more processors to:
provide for display an input field associated with a particular role card object of the role card objects included in the generated workflow dataset based on determining that the corresponding calculated variance value exceeds a defined threshold variance value; and
store a dimension value received via the displayed input field in association with the particular role card object.

30. The medium of claim 29, wherein each variation value calculated for at least the portion of the calculated variation values is determined to exceed the defined threshold variance value.

31. The medium of claim 29, wherein the GUI is generated based further in part on the stored dimension value.

32. A computerized system comprising:
a standard workflow generating means for generating a workflow dataset that includes a set of role card objects selected from a stored plurality of role card objects, each role card object of the set of role card objects being selected based on corresponding metadata of the role card object determined to correspond to a portion of a received electronic plan; and
a standard workflow tracking means for determining that a variation value calculated for a particular role card object of the included set of role card objects exceeds a defined threshold variation value, wherein the variation value is calculated based on a standard duration defined in the particular role card object and an actual duration recorded based on a received set of inputs.

33. The system of claim 32, further comprising:
a workflow analysis means for generating metrics data associated with at least the generated workflow dataset, the metrics data being generated based at least in part on the calculated variation value and the determination that the calculated variation value exceeds the defined threshold variation value.

34. The system of claim 33, further comprising:
a metric defining means for generating a selectable metric criteria associated with the generated analytics interface based on one or more inputs received via a metric interface, wherein the generated selectable metric criteria is employable to filter at least the particular role card object.

35. The system of claim 32, further comprising:
a workflow management means for storing an association between the particular role card object and a selected user account.
